(19) United States
(12) Patent Application Publication
(10) Pub. No.: US 2018/0114455 A1
(43) Pub. Date: Apr. 26, 2018

(54) ASSESSMENT SYSTEM, DEVICE AND SERVER

(71) Applicant: PHIXOS LIMITED, Worcester (GB)

(72) Inventors: Richard Brecknell, Rushwick (GB); John Minihan, Solihull (GB); Alberto Molteni, Newport (GB)

(21) Appl. No.: 15/337,103

(22) Filed: Oct. 28, 2016

(30) Foreign Application Priority Data
Oct. 26, 2016 (GB) 1618115.8

(51) Int. Cl. G09B 7/00; H04L 29/08

(52) U.S. Cl. CPC G09B 7/00; H04L 67/10

(57) ABSTRACT

A tamper-resistant electronic assessment system using time indicators to ensure electronic assessment integrity is provided. The assessment system may include an assessment server configured to generate an assessment instance including at least one question and an assessment device configured to present the assessment to a user. The assessment device may send a first current time indicator to the assessment server, receive the assessment instance, receive user answers, send the user answers to the assessment server, and send a second current time indicator to the assessment server to facilitate verification of the assessment integrity. The assessment server may further determine first and second time differences between the first current time indicator and second current time indicator and the current times when they are received by the assessment server. The assessment server may further generate an alert when the first and second time differences differ by more than a predetermined period.

### CROSS-REFERENCE TO RELATED APPLICATIONS

This application claims the benefit of U.K. Application No. 1618115.8, filed Oct. 26, 2016, the entirety of which is hereby incorporated herein by reference.

### TECHNICAL FIELD

The present disclosure generally relates to a system and a method for improved electronic assessment security, using current time indicators to provide a tamper-resistant electronic assessment system.

### BACKGROUND

Computer-based assessments and, in particular, Internet-based assessments have become a useful tool for many businesses and educational establishments.

Such assessments can be centrally coordinated and controlled, and marked by the computer system objectively to provide fast results. When candidates are spread over a wide geographic area, the distribution of assessments over the Internet has numerous advantages. For example, assessments can be reliably distributed in an efficient manner, and the availability of the assessments can be more readily controlled.

However, such assessment systems are prone to cheating and only provide limited feedback about a candidate.

In addition, such assessment systems are also prone to security and robustness issues, with heavy reliance on continuous communication between a server and a candidate device. A break in that communication can result in the assessment being invalidated or incorrectly marked. This makes such assessment impractical in some environments. Efforts to tackle such problems have conventionally then led to security flaws and opened the door to potential tampering.

There is a need, therefore, to provide an assessment system which seeks to alleviate one or more of the problems associated with existing assessment systems.

### SUMMARY

Embodiments of the present invention relate to an assessment system for the delivery of an assessment instance to one or more assessment devices.

Accordingly, an aspect provides an assessment system including: an assessment server configured to generate an assessment instance including a question; an assessment device including: an input sub-system; an output sub-system; and an input/output sub-system, the assessment device configured to: send, using the input/output sub-system, a first current time indicator to the assessment server at a first time, receive, using the input/output sub-system, the assessment instance from the assessment server, present the question to a user using the output sub-system, receive, via the input sub-system, an answer to the question, send the answer to the assessment server, and at a second time, subsequent to the first time, send a second current time indicator to the assessment server, wherein the assessment server is further configured to determine a first time difference between the first current time indicator and the current time when the first current time indicator is received by the assessment server, to determine a second time difference between the second current time indicator and the current time when the second current time indicator is received by the assessment server, to compare the first and second time differences, and to generate an alert when the first and second current time differences are different from each other by more than a predetermined period.

The assessment device may be further configured to monitor the time taken between the presentation of the question to the user and receipt of the answer, generate a time taken indicator representative of the time taken, and send the time taken indicator to the assessment server.

The assessment server may be further configured to determine a confidence factor based at least in part on the time taken indicator.

The assessment device may be further configured to monitor one or more changes of the answer received by the assessment device, generate an change indicator representing the number of changes of the answer, send the change indicator to the assessment server, and wherein the assessment server may be further configured to determine the confidence factor based at least in part on the change indicator.

The assessment system may further include one or more administrator devices, wherein the alert may be sent to at least one of the one or more administrator devices.

The answer may be stored on a storage medium of the assessment device.

The answer may be stored as a cookie.

The assessment device may be further configured to monitor the time taken between the presentation of the question to the user and receipt of the answer, generate a time taken indicator representative of the time taken, and to store the time taken indicator on the storage medium of the assessment device.

The answer and time taken indicator may be encrypted and stored as a cookie.

The assessment system may further include an administrator device, wherein the assessment device is further configured to monitor the time taken between the presentation of the question to the user and receipt of the answer, generate a time taken indicator representative of the time taken, and send the time taken indicator to the assessment server, wherein the assessment server is further configured to determine a confidence factor based at least in part on the time taken indicator and to determine a score based on the answer, and wherein the administrator device is further configured to receive at least one representation of the confidence factor and score.

The assessment server may include a storage medium on which is stored a body of questions, and at least one assessment template which defines one or more characteristics of an assessment, wherein the assessment server may be further configured to generate the assessment instance such that the question included in the assessment instance is selected from the body of questions based at least in part on the assessment template.

The assessment system may further include one or more additional assessment devices, wherein the assessment server may be further configured to generate one or more further assessment instances and to send each of the one or more additional assessment devices a respective one of the one or more further assessment instances.

Another aspect provides an assessment device including: an input sub-system, an output sub-system, and an input/output sub-system, wherein the assessment device is configured to: send, using the input/output sub-system, a first current time indicator to an assessment server at a first time, receive, using the input/output sub-system, the assessment instance from the assessment server, present the question to a user using the output sub-system, receive, via the input sub-system, an answer to the question, send the answer to the assessment server, at a second time, subsequent to the first time, send a second current time indicator to the assessment server, and receive an alert from the assessment server indicating cheating has occurred based at least in part on the first current time indicator and the second current time indicator.

The assessment device may be further configured to monitor the time taken between the presentation of the question to the user and receipt of the answer, generate a time taken indicator representative of the time taken, and send the time taken indicator to the assessment server.

The assessment device may be further configured to monitor one or more changes of the answer received by the assessment device, generate an change indicator representing the number of changes of the answer, send the change indicator to the assessment server.

Another aspect provides an assessment server configured to: generate an assessment instance including a question; receive a first current time indicator from an assessment device at a first time; send the assessment instance to the assessment device; receive an answer to the question from the assessment device; at a second time, subsequent to the first time, receive a second current time indicator from the assessment device; determine a first time difference between the first current time indicator and the current time when the first current time indicator is received; determine a second time difference between the second current time indicator and the current time when the second current time indicator is received; compare the first and second time differences; and generate an alert when the first and second current time differences are different from each other by more than a predetermined period.

The assessment server may be further configured to receive a time taken indicator from the assessment device.

The assessment server may be further configured to determine a confidence factor based at least in part on the time taken indicator.

The assessment server may be further configured to receive a change indicator from the assessment device, and determine the confidence factor based at least in part on the change indicator.

The assessment server may be further configured to send the alert to an administrator device.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 shows an overview of an assessment system of some embodiments;

FIG. 2 shows a schematic view of an assessment server of some embodiments;

FIG. 3 shows a schematic view of an assessment device or administrator device of some embodiments;

FIG. 4 shows a login interface of some embodiments;

FIG. 5 shows an initial options interface of some embodiments;

FIG. 6 shows a privilege management interface of some embodiments;

FIG. 7 shows a settings interface of some embodiments;

FIG. 8 shows a question management interface of some embodiments;

FIG. 9 shows a new question interface of some embodiments;

FIG. 10 shows a template management interface of some embodiments;

FIG. 11 shows a new template interface of some embodiments;

FIG. 12 shows a deployment management interface of some embodiments;

FIG. 13 shows a new deployment interface of some embodiments;

FIG. 14 shows an assessment selection interface of some embodiments;

FIG. 15 shows an assessment interface of some embodiments;

FIG. 16 shows a results analysis interface of some embodiments;

FIG. 17 shows a results overview interface of some embodiments;

FIG. 18 shows an assessor dashboard interface of some embodiments;

FIG. 19 shows aspects of an assessment system of some embodiments;

FIG. 20 shows a schematic view of an assessment of some embodiments; and

FIGS. 21-31 show representations according to some embodiments.

### DETAILED DESCRIPTION

Although the following text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

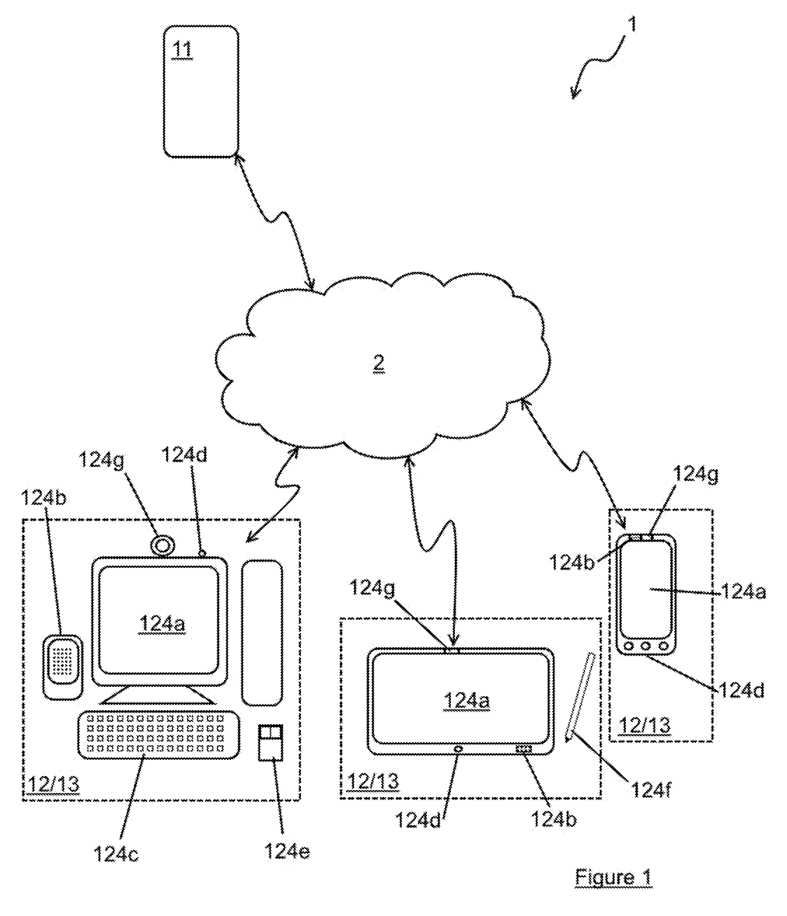

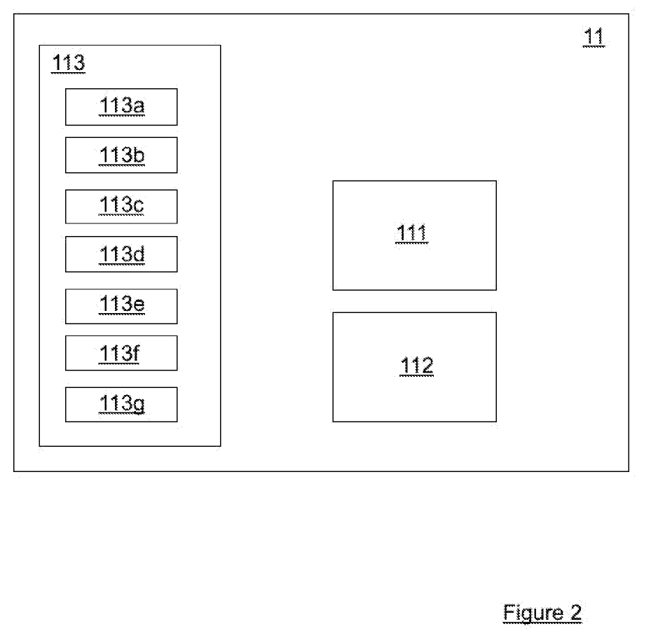

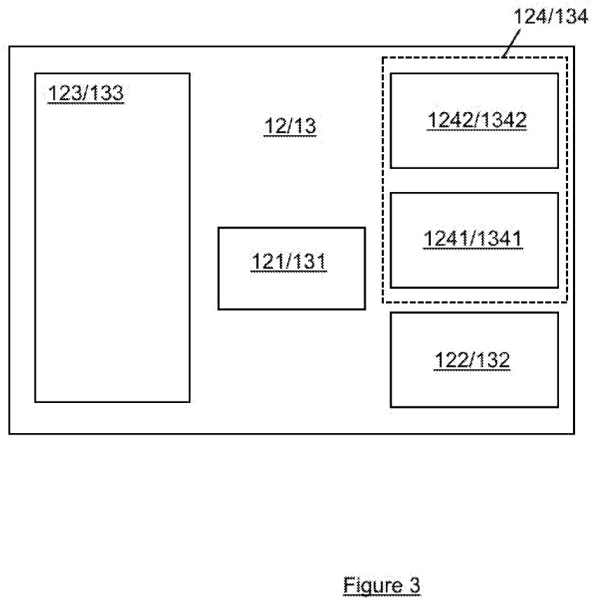

With reference to FIGS. 1-3, for example, embodiments may be implemented in using an assessment system 1. The assessment system 1 could take a number of different forms and could include different combinations of the elements described herein.

The assessment system 1 may include an assessment server 11 which is communicatively coupled to one or more assessment devices 12 and may be communicatively coupled to one or more administrator devices 13.

The assessment server 11 is a computing device and, as such, includes a central processing unit 111, and an input/output sub-system 112. The assessment server 11 may also include or be communicatively coupled to a storage medium 113 (i.e., a tangible, non-transitory storage medium) which is configured to store instructions which, when executed by the central processing unit 111, cause the assessment server 11 to perform one or more operations—as described herein. The input/output sub-system 112 is configured to provide at least part of the communicative coupling between the assessment server 11 and the or each assessment device 12 and/or the or each administrator device 13.

The communicative coupling between the assessment server 11 and the or each assessment device 12 and/or the or each administrator device 13 may be via a network 2. The network 2 may include a local area network and/or a wide area network. In embodiments in which the network 2 includes a wide area network, the wide area network may include the Internet. The network 2 may include a wired and/or wireless network (the wireless network may include a Wifi, WiMax, or wireless cellular network, for example).

The or each assessment device 12 is a computing device and, as such, includes a central processing unit 121, and an input/output sub-system 122. Like the assessment server 11, the or each assessment device 12 may also include or be communicatively coupled to a storage medium 123 (i.e., a tangible, non-transitory storage medium) which is configured to store instructions which, when executed by the central processing unit 121, cause the assessment device 12 to perform one or more operations—as described herein. The input/output sub-system 122 is configured to provide at least part of the communicative coupling between the assessment device 12 and the assessment server 11.

The assessment device 12 further includes a user interface sub-system 124 which is configured to receive one or more inputs from a user and to provide one or more outputs to the user. The or each input may be delivered from the user interface sub-system 124 to the central processing unit 121 for use in the performance of the one or more operations—as described herein. The or each output may be generated by the one or more operations. The user interface sub-system 123 may, therefore, include an input sub-system 1241 and an output sub-system 1242. The input sub-system 1241 may include one or more of keyboard 124c, a mouse 124e, a microphone 124d, a stylus 124f, a touch-sensitive display 124a, and a camera 124g, for example. The output sub-system 1242 may include one or more of a display 124a (which may be a touch-sensitive display 124a), and a speaker 124b, for example.

The assessment device 12 may be, for example, a portable computing device such as a laptop, a tablet, a mobile (i.e. cellular) telephone, or the like. The assessment device 12 may be, for example, a desktop computer or similar.

The administrator device 13 may be a device which is generally identical in form to the assessment device 12. The description above in relation to the assessment device 12, therefore, applies equally to the administrator device 13. Accordingly, the administrator device 13 may include a central processing unit 131, an input/output sub-system 132, storage medium 133 (i.e., a tangible, non-transitory storage medium) (or may be communicatively coupled to a storage medium 133), a user interface sub-system 134 (which may include an input sub-system 1341 and an output sub-system 1342—which may be as described in relation to the corresponding elements of the assessment device 12).

The instructions which are configured to cause the assessment server 11, the assessment device 12, and the administrator device 13, to perform one or more operations are may be provided in different combinations and arrangements to achieve the described operations. Indeed, embodiments may include a computer implemented method which is performed using the assessment server 11 and one or more assessment devices 12 (and/or one or more administrator devices 13).

The instructions which are configured to cause the assessment server 11 to perform one or more operations, may include instructions which are configured to cause the assessment server 11 to serve (i.e. deliver) data (e.g. in the form of one or more computer files) to the one or more assessment devices 12 and/or one or more administrator devices 13. The data may include one or more webpages which may be provided in the form of one or more hypertext markup language (HTML) files. These one or more webpages may include one or more interpreted language program instructions which are interpreted by an application on the or each assessment device 12 and/or administrator device 13 as the case may be. These one or more interpreted language program instructions may be written using an interpreted programming language such as JavaScript®, although the use of other such languages is also envisaged in some embodiments. In general, the data which may be served by the assessment server 11 to the one or more assessment devices 12 and/or administrator devices 13 may be referred to herein as served data.

The instructions which are configured to cause the assessment server 11 to perform one or more operations may include instructions which are configured to receive data from the or each assessment device 12 and/or administrator device 13. This data may be provided in the form of one or more computer files, or may be, for example, in the form of a data string. In general, the data which may be received by the assessment server 11 from the or each assessment device 12 and/or administrator device 13 may be referred to herein as returned data.

The instructions which are configured to cause the assessment server 11 to perform one or more operations may include instructions which control one or more internal operations of the assessment server 11. This may include operations involving the analysis of data, the storage of data, the retrieval of the data, and the like. These internal operations may include a clock operation. The clock operation is configured to maintain a time indication. The clock operation may be configured to use an internal clock circuit of the assessment server 11 to monitor the passage of time and may use a manually or automatically determined setting to associate the passage of time with an absolute time indicator (i.e. an indication of the current time in terms of the day of the month, month of the year, the year, the hour of the day, and the minute of that hour (a finer absolute time indicator may also be maintained such as the second of the minute, and/or the tenth of the second, the hundredth of the second, and/or the thousandth of the second, etc.). The absolute time indicator may be manually determined in that a user may manually indicate to the assessment server 11 the current time at a given moment and the assessment server 11 may then update the current absolute time indicator based on that manually indicated time and the passage of time as determined by the internal clock circuit. The absolute time indicator may be automatically determined in that the assessment server 11 may determine the current time at a given moment from a remote clock—e.g. using a service available to the assessment server 11 over the Internet or other network 2—and, again, may use the internal clock circuit to update the absolute time indicator based on the automatically obtained indication and the passage of time. In the case of an automatically determined absolute time indicator, the current absolute time indicator may be periodically cross-checked with the remote clock and the current absolute clock indicator updated if a discrepancy is noted.

The instructions which are configured to cause the or each assessment device 12 and/or administrator device 13 to perform one or more operations may include instructions which are configured to receive the served data from the assessment server 11 and to interpret that data in order to present information to the user via a respective output sub-system 1242,1342.

Accordingly, in some embodiments, those instructions may include instructions which comprise a browser application 3 (such as an Internet browser) which is configured to receive served data in the form of one or more webpages and to present those one or more webpages to the user via the output sub-system 1242,1342—such as a display 124a and/or a speaker 124b. Accordingly, as will be appreciated, the served data may include visual data (e.g. for a web page, which may include one or more images and/or one or more videos) and may also or alternatively include audio data (e.g. an audio track and/or audio as part of one or more videos). This received served data may be referred to herein as received served data.

The instructions which are configured to cause the or each assessment device 12 and/or administrator device 13 to perform one or more operations may include instructions which cause data to be sent to the assessment server 11. These instructions may form part of the browser application 3 and/or may be provided separately. This data, once received at the assessment server 11, may form the returned data. Generally, the data which may be sent to the assessment server 11 by the or each assessment device 12 and/or administrator device 13 may be generally referred to herein as sent data.

The instructions which are configured to cause the assessment device 12 and/or administrator device 13 to perform one or more operations may include instructions which control one or more internal operations of that device 12,13. This may include operations involving the analysis of data, the storage of data, the retrieval of the data, and the like. These internal operations may include a clock operation (much like the clock operation of the assessment server 11). This clock operation is configured to maintain a time indication. The clock operation may be configured to use an internal clock circuit of the device 12,13 to monitor the passage of time and may use a manually or automatically determined setting to associate the passage of time with an absolute time indicator (i.e. an indication of the current time in terms of the day of the month, month of the year, the year, the hour of the day, and the minute of that hour (a finer absolute time indicator may also be maintained such as the second of the minute, and/or the tenth of the second, the hundredth of the second, and/or the thousandth of the second, etc.). The absolute time indicator may be manually determined in that a user may manually indicate to the device 12,13 the current time at a given moment and the device 12,13 may then update the current absolute time indicator based on that manually indicated time and the passage of time as determined by the internal clock circuit. The absolute time indicator may be automatically determined in that the device 12,13 may determine the current time at a given moment from a remote clock—e.g. using a service available to the device 12,13 over the Internet or other network 2—and, again, may use the internal clock circuit to update the absolute time indicator based on the automatically obtained indication and the passage of time. In the case of an automatically determined absolute time indicator, the current absolute time indicator may be periodically cross-checked with the remote clock and the current absolute clock indicator updated if a discrepancy is noted.

The instructions which are configured to cause the or each assessment device 12 and/or administrator device 13 to perform one or more operations may include instructions which receive information input by the user through the respective input sub-system 1241,1341—such as the keyboard 124c, the touch-sensitive display screen 124a, the microphone 124d, the mouse 124e, the stylus 124e, and/or the camera 124g. This received information may then be interpreted by the device 12,13 in the performance of one or more other operations (e.g. in relation to the browser application) and the sent data may be at least partially based on this received information.

The assessment server 11, the or each assessment device 12 and/or the or each administrator device 13, are communicatively coupled via the network 2 as described. As will be appreciated, therefore, the server 11 and the or each device 12,13 may have one or more respective identifiers associated therewith. These identifiers may include, for example, an address on the network 2 and may include an Internet protocol address (an “IP address”) and/or a media access control address (a “MAC address”).

As will be appreciated, the assessment server 11, the or each assessment device 12, and/or the or each administrator device 13 may be geographically remote from each other—e.g. in different rooms, buildings, cities, counties/states, countries, continents, etc. There may be a plurality of assessment devices 12 which are all located at one general geographic location (e.g. in the same room or building, such as a test centre) and the assessment server 11 may be at a different geographic location but could also be at the same general geographic location. The same is true of the or each administrator device 13.

The assessment system 1 of embodiments is used for the delivery of assessments to users, the collection of the responses to those assessments, and the analysis of the assessments.

The assessments could relate to any number of different topics and could be for any number of different purposes. For example, the assessment could be an assessment for a job or a promotion in which the assessor (i.e. the party responsible for initiating the assessment) is seeking the likely most suitable candidate or candidates for a particular position.

The assessments could relate to training process in order to assess the user as to their competence in particular area—e.g. after a training course in that area or even prior to determining what training the user may require. This training could include safety training, maintenance training, customer relations training, education training (e.g. assessing general competence in mathematics, language and/or the like), technical training, driver training, equipment operation training, and the like.

It is envisaged that embodiments could be used in a number of different situations in which questions are presented to a user and the user is asked to respond in order to assess the user in some manner.

Some embodiments seek to provide a platform from which multiple such assessments can be managed and delivered to users. Some embodiments seek to provide additional information about the user responses other than merely whether the response was correct or incorrect.

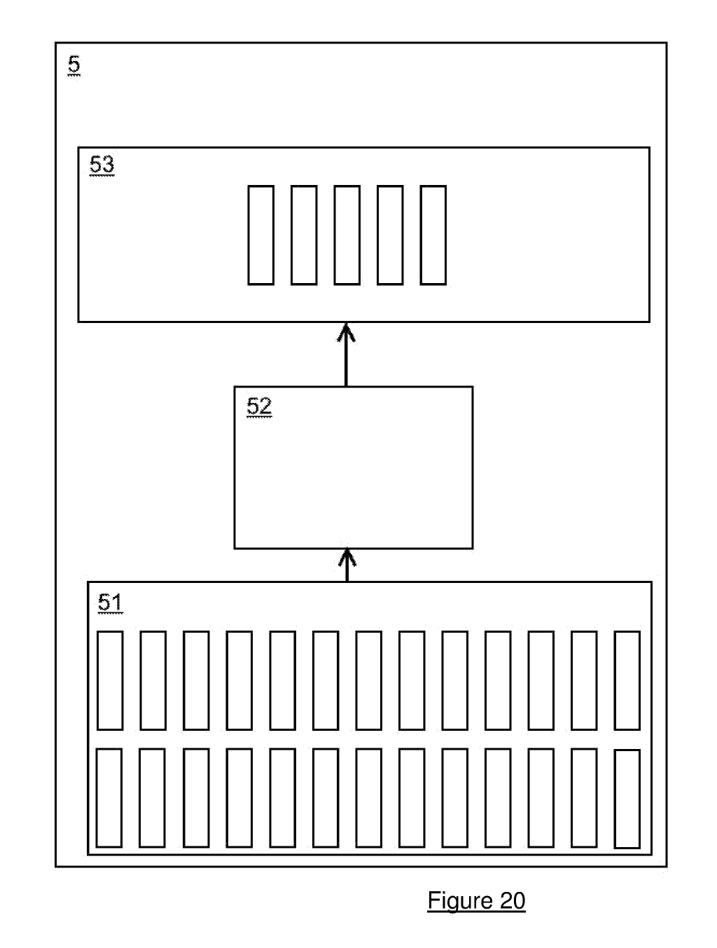

In general, embodiments may be used to generate an assessment 5. An assessment 5 includes a body of questions 51 which may be called upon for inclusion in a particular assessment instance 53. The assessment 5 may include an assessment template 52 which is used, in combination with the body of questions 51, in order to generate the particular assessment instance 53. A plurality of assessment instances 53 may, therefore, be generated from a single assessment 5 of embodiments. An assessment instance 53 may be, therefore, a set or subset of the body of questions 51 selected in accordance, at least in part, with the assessment template 52. This is generally shown in FIG. 20 in which it can be seen that an assessment template 52 uses a body of questions 51 to generate an assessment instance 53 for the assessment 5 (the assessment instance 53, in this example, includes on a selection of the questions from the body of questions 51).

The operations of some embodiments will be described initially from the perspective of the operation of one of the one or more administrator devices 13 and the assessment server 11. However, it will be apparent that not all embodiments necessarily require the presence or use of an administrator device 13.

In accordance with some embodiments, when a first user intends to assess a second user, then the first user uses one of the one or more administrator devices 13 to initiate contact with the assessment server 11. As will be appreciated, therefore, the first user may be generally known as an assessor or an administrator and the second user may be generally known as a candidate.

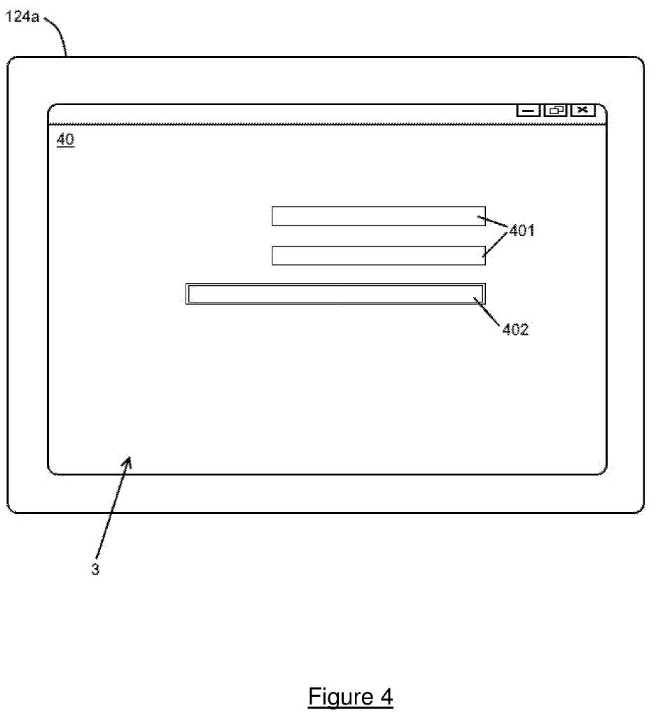

Initiating contact may comprise the administrator device 13 of the assessor sending a request to the assessment server 11. This request may include a request for a login interface 40 (such as a web page), for example—see FIG. 4, for example. The request may be sent through the browser application 3 of the administrator device 13 and may be caused by the assessor entering an address for the assessment server 11 into a field within the browser 3. For example, the address may be a uniform resource locator (URL) or IP address or other network address for the assessment server 11. The request, therefore, is an example of sent data.

The assessment server 11 may be configured to receive the request and to serve data (as an example of served data) which may include the login interface 40. This login interface 40 may be provided in as a web page, for example. The login interface 40 may include one or more fields 401 into which the assessor can enter authentication information to authenticate the assessor. This information may include one or more of a username and a password, for example.

The authentication information may be sent (e.g. on actuation of a button 402 of the login interface 40 by the user) by the administrator device 13 to the assessment server 11. This authentication information is, therefore, another example of sent data. The authentication information may be encrypted prior to being sent to the assessment server 11, for example. Indeed, the sent data in general may be encrypted before being sent and similarly the served data may also be encrypted before being sent.

On receipt of the authentication information from the administrator device 13, the assessment server 11 may, in some embodiments, decrypt the authentication information. The assessment server 11 may be further configured to check the authentication information received from the administrator device 13 against account information 113a. The account information 113a may be stored on the storage medium 113 associated with the assessment server 11.

If the assessment server 11 has a record of the authentication information in relation to an account 113b for which account information 113a is stored, then the assessment server 11 may be configured to determine that the assessor is an authenticated user of that account 113b.

The assessment server 11 may have access to data associated with one or more accounts 113b. For example, data stored on the storage medium 113 associated with the assessment server 11 may be divided into data for those one or more accounts 113b, or for one or more groups 113c of accounts 113b. As such, an assessor authenticated for a particular account 113b may be able to access—as described herein—the data stored for that account 113b or group 113c of accounts 113b but may be prohibited or otherwise prevented from accessing data stored for another account 113b or group 113c of accounts 113b.

A group 113c of accounts 113b may be, for example, a group of accounts which are all associated with a particular organisation, such as a test centre, or a particular location, or a particular course, for example.

As will become apparent, accounts 113b may be assessor accounts or candidate accounts. There may be more than one assessor account in a group 113c and there may be more than one candidate account in a group 113c. However, there is typically, at least one assessor account in each group 113c. The assessor account may be an administrator account which can control one or more aspects of the assessment which the assessment system is configured to provide. In some embodiments, however, not allow assessor accounts are administrator accounts and/or there may be at least one administrator account which is not also an assessor account.

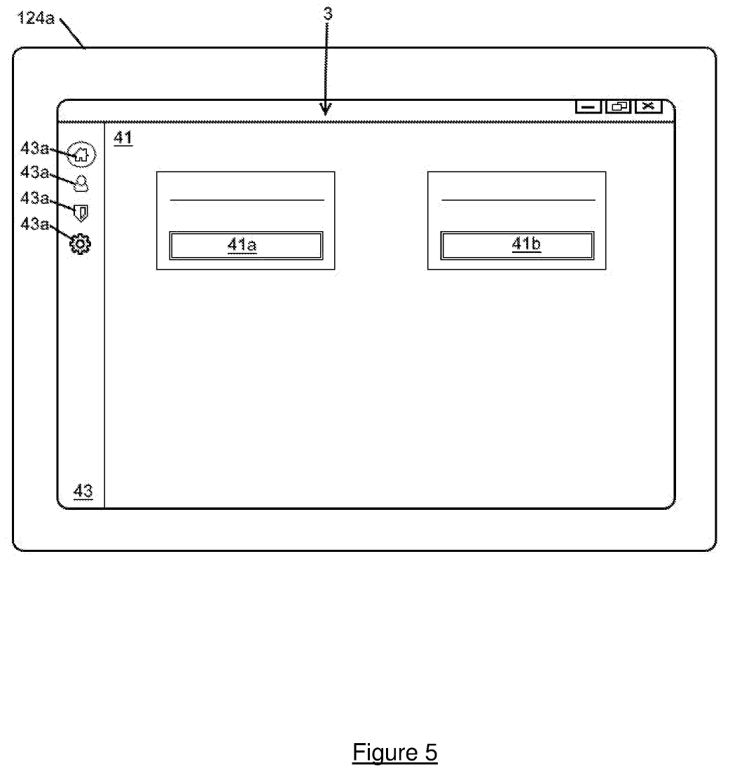

On determining that the assessor is authenticated for an account, then the assessment server 11 may send served data to the administrator device 13 which is intended to cause the administrator device 13 to present an initial options interface 41 to the assessor—see FIG. 5, for example. That data, another example of served data, may include one or more web pages, for example, and may be received as received served data by the administrator device 13. In some embodiments, the initial options interface 41 is only displayed after authentication if certain criteria are met: for example, the assessor has not previously accessed the assessment system 1 and/or there are not accounts 113b in the group 113c of which the assessor account is a part.

The initial options interface 41 may include a user selectable option 41a for the assessor, using the administrator device 13, to manage one or more accounts 113b in the group 113c of which the assessor account is a member, and/or may include a user selectable option 41b for the assessor, using the administrator device 13, to manage privileges associated with the one or more accounts 113b in the group 113c of which the assessor account is a member.

Selection of the option to manage 41a the one or more accounts 113b may cause the sending of that selection from the administrator device 13 to the assessment server 11 as sent data. In response, the assessment server 11 may be configured to serve data to the administrator device 13 which is intended to cause the administrator device to display a user management interface (not shown). The user management interface may be in the form of a web page, for example, and may be an example of served data which is received as received served data.

The user management interface may be configured, through one or more fields, to allow the assessor to enter information about one or more other users—such as usernames, names, addresses, email addresses, course information, other identifiers, and the like. The assessment server 11 may be configured to receive this data from the administrator device 13 as sent data and to create and/or modify one or more accounts corresponding with the data entered by the assessor. In some embodiments, the user management interface includes options which allow the assessor to upload (as sent data) a predefined set of information about one or more other users—e.g. as a document file, a database file, a spread sheet file, or the like. This may, for example, reduce the burden on the assessor entering the information when records may already exist in an electronic format (e.g. from course enrolment information).

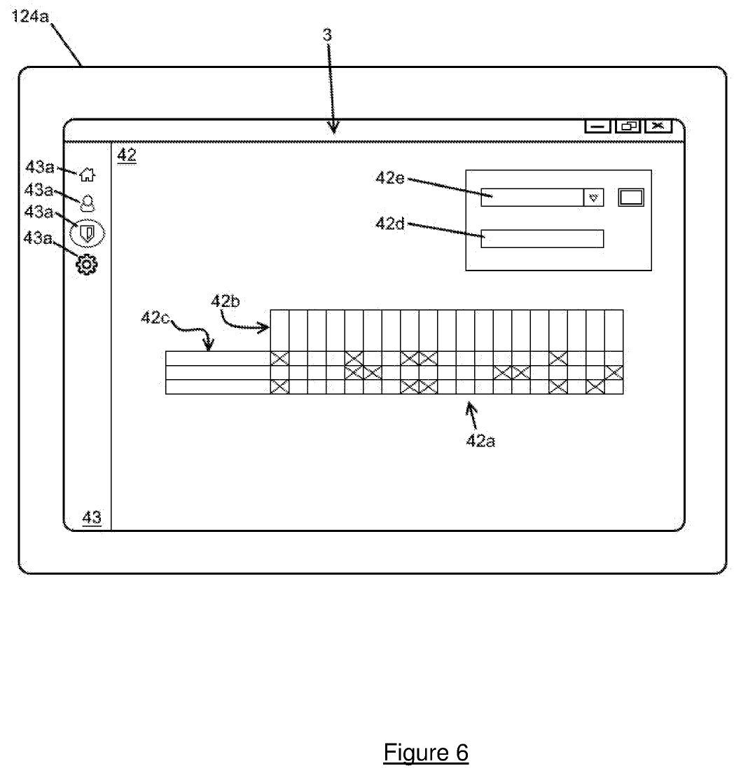

Selection of the option 41b to manage privileges associated with the one or more accounts 113b in the group 113c may cause the sending of that selection from the administrator device 13 to the assessment server 11 as sent data. In response, the assessment server 11 may be configured to serve data to the administrator device 13 which is intended to cause the administrator device to display a privilege management interface 42—see FIG. 6. The privilege management interface 42 may be in the form of a web page, for example, and may be an example of served data which is received as received served data.

The privilege management interface 42 may include assessor configurable options 42a for one or more privileges associated with the one or more accounts 113b in the group 113c of which the assessor account 113b is a part.

For example, the privilege management interface 42 may display a list of privileges 42b and a list of accounts 42c in a tabular format. The privileges 42b may be listed as a series of columns and the accounts 42c may be listed as a series of rows. The privilege management interface 42 may include user selectable tick boxes or the like as the configurable options 42 to enable the assessor to change the privileges associated with each account. Changes made by the assessor via the privilege management interface 42 may be sent to the assessment server 11 and may be stored in association the relevant accounts 113b and/or with a single record retained in association with the group 113c.

The privilege management interface 42 may include options 42d which allow the assessor to filter the list of accounts presented—which may be useful if there are a large number of such accounts. The filtering may be via one or more aspects of the information stored for each account 113b and/or by the existing privileges of each account 113b in the group 113c.

The filtering may be performed locally on the administrator device 13 which, having received the account 113b information and privilege information may be configured to process the information and to present information based on the selected filter.

The filtering may be performed by the assessment server 11 by the filter selection being sent to the assessment server 11 as sent data and the assessment server 11 receiving this information and returning a filtered list of account privilege information for an updated privilege management interface 42.

In some embodiments, the privilege management interface 42 may include a field 42e configured to receive an identifier for one or more accounts 113b to be added to the interface 42—allowing the assessor to build the list of accounts 113b as desired. This may be achieved by the provision of a drop-down menu, for example, which lists the accounts 113b in the group 113c. Again, this displaying of account privilege information in the privilege management interface 42 may be performed local by the administrator device 13 or by the assessment server 11 (by the sending of the assessor selection of accounts to the assessment server 11 as sent data and the return of an updated privilege management interface 42).

The privilege information 113d may be sent to the assessment server 11 as sent data and stored in the associated storage medium 113. This privilege information 113d may be stored in relation to the accounts 113a (i.e. in the record for each account 113a) or may be stored as a separate record of the privilege information 113d which associates the privileges with the accounts 113b.

In some embodiments, one or more of the user interfaces which are presented to the assessor via the administrator device 13 include a ribbon 43 which allows the user to select one or more user interfaces. The ribbon 43 may, for example, therefore, include one or more user selectable items such as text or icons 43a.

The selection of a particular selectable item 43a may cause the identity of the selection to be sent to the assessment server 11 as sent data. The assessment server 11 may, in response, return a served data which is, when received as received served data, intended to cause the administrator device 11 to present an associated user interface. This may include, for example, the initial options interface 41, the user management interface, or the privilege management interface 42 as described herein. This may also include one or more other user interfaces as described herein. When a particular user interface is presented via the administrator device 13, the associated selectable item 43a may be marked to indicate which user interface is being presented—this may include, for example, the illumination or highlighting of the associated selectable item 43a. Accordingly, the ribbon 43 may be visible irrespective of which user interface is also being presented—i.e. the ribbon 43 may be a persistent element of the user interfaces (or a persistent ribbon 43). The ribbon 43 is depicted as a vertical ribbon but may be a horizontal ribbon in some embodiments.

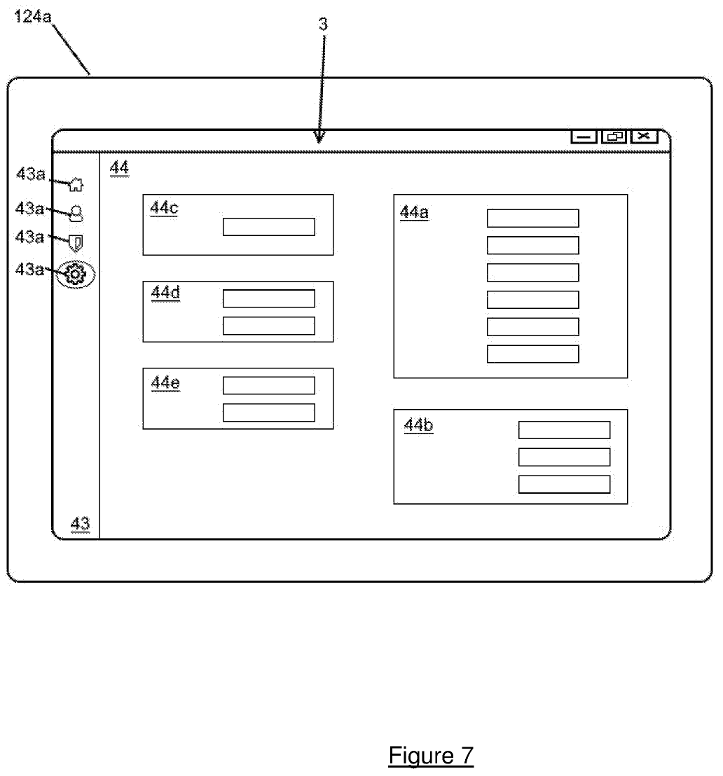

The one or more other user interfaces may include, for example, a settings interface 44—see FIG. 7.

The settings interface 44 may include one or more options which the assessor can set in relation to all accounts 113b in the group 113c of which the assessor account is a member. The one or more options may specify, for example, one or more attributes of the assessments which can be configured according to embodiments for this group 113c.

For example, the one or more options may include options for the type of questions/answers 44a which can be included in any assessment which is configured for the group 113c. The types of questions/answers 44a may include multiple choice, free text, drag-and-drop (in which a plurality of answers may be dragged and dropped into appropriate answer locations), intensity scale (e.g. Likert scale), and short answer (i.e. free text with a low maximum word or character count). Via the options presented in this part of the settings interface 44, the assessor may set the types of questions and answers which are, in general, permitted.

The one or more options may include one or more detailed specific options 44b which are enabled for selection if one of the other options 44a is selected. For example, if multiple choice questions/answers are permitted (i.e. if this option is selected) then the or each detailed specific option 44b may include a setting for the minimum number of choices which can be presented in the question, the maximum number of choices which can be presented in the question, the total number of choices which can be presented in the question, the maximum number of correct answers, the minimum number of correct answers, and the number of correct answers, how short answers should be marked (e.g. strictly or permissively), and whether manual marking of short answers should be permitted.

The strict marking of short answers means that the answer to a question is only identified as correct, if the answer matches the actual answer exactly—e.g. one or more of spelling and case. In permissive marking of short answers acceptable answers may include answers which include at least one character which is of a different case to that character in the actual answer and/or which are phonetically correct or almost correct but which are spelt incorrectly.

The one or more options may include one or more contact settings 44c such as whether or not the assessment server 11 is allowed to contact the assessors and/or candidates using the email addresses which are included in the information associated with their respective accounts—such email communication may include indications as to when the assessment is available to be sat, reminders for the sitting of the assessment, and results of the assessment.

The one or more options may include a maximum overlap setting 44d which is a setting which determines the maximum overlap of questions which is permitted between an initial assessment and a resit of the assessment (which may be different instances 53 of the same assessment 5, for example).

The one or more options may also include one or more alert options 44e for alarms or other alerts to be initiated in the event of one or more pre-defined events. For example, if a particular question has fewer than a (assessor selectable) threshold number or proportion of correct answers then the assessor can be alerted. Similarly, if a particular question has more than a (assessor selectable) threshold number or proportion of correct answers then the assessor can be alerted. This helps to ensure the quality of the questions which are presented.

The selection of these options 44a-44e may be sent, as sent data, to the assessment server 11 for storage on the storage medium 113 as stored setting options 113e. In some embodiments, the setting options 113e are stored separately from the group 113c record which is stored on the storage medium but is associated therewith—in other embodiments, the setting options are stored with the record for the group 113c.

In some embodiments, the initial options interface 41, the privilege management interface 42, the account management interface, and the settings interface 44, may be accessible to an administrator but not to an assessor.

The creation and management of questions for use in assessments which are generated by the assessment system 1 may include a number of stages and the use of a number of interfaces as are described herein.

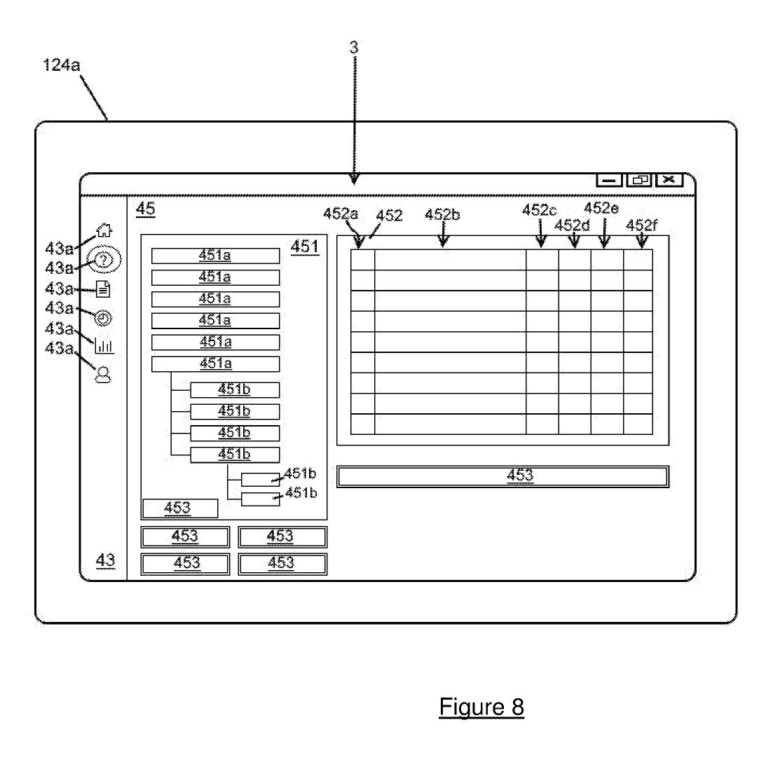

Accordingly, the one or more other user interfaces may include, for example, a question management interface 45—see FIG. 8.

The question management interface 45 is configured to receive question and actual answer information from the assessor via the administrator device 13 in order for the assessment server 11 to compile the body of questions 51.

The question management interface 45 may be configured to present a navigation panel 451 for the body of questions 51. The navigation panel 451 may present the body of questions 51 (which may be known as a bank of questions) in accordance with an organised hierarchy. The organised hierarchy may be arranged in accordance with any number of suitable configurations so as to achieve straightforward navigation and selection of questions from the body of questions 51.

For example, the body of questions 51 may be separated according to topic or subject such that there is a plurality of topics or subjects 451a listed in the navigation panel 451. The selection by the assessor via the administrator device 13 of one of the plurality of topics or subjects 451a may cause the presentation of a sub-set of the body of questions 51 which are associated with that topic or subject 451a in a question list panel 452. This may be achieved locally by the administrator device 13 identifying the sub-set from the body of questions 51 wherein the assessment server 11 has sent the body of questions 51 to the administrator device 13. In other embodiments, the body of questions 51 is held by the assessment server 11 and the selection of one of the plurality of topics or subjects 451a is sent, as sent data, to the assessment server 11 which returns the sub-set of body of questions 51 to the administrator device 13 for presentation in the question list panel 452.

In some embodiments, one or more of the plurality of topics or subjects 451a is further divided into one or more sub-groups 451b. The selection by the assessor of one of the plurality of topics or subjects 451a may cause the presentation in the navigation panel 451 of one or more sub-groups 451b. In turn, the selection of one of the one or more sub-groups 451b may cause the presentation of an associated sub-group of the sub-set of the body of questions 51 in the question list panel 452. Again, this may be performed locally or in the assessment server 11.

The organised hierarchy may include more levels—i.e. there may be sub-groups of sub-groups, for example—with the navigation panel 451 allowing for navigation through the hierarchy and the presentation of the associated questions from the body of questions in the question list panel 452.

The sub-groups may, for example, be more specific topics or subjects, or may be different difficult levels.

The navigation panel 451 may be configured to present the one or more topics or subjects 451a and, if applicable, the one or more sub-groups 451b in a tree-like navigation structure. The assessor may, therefore, via the administrator device 13 may able to expand and collapse parts of the presented hierarchy to show or hide parts thereof.

The question list panel 452 may present a summary of the details of the relevant question or questions from the body of questions 51 depending on the selection made in the navigation panel 451.

The summary details may include one or more of a question identifier 452a (i.e. a question ID), a question subject indicator 452b, a question type 452c, a question level 452d, a question media indicator 452e, and a question status indicator 452f.

The question ID 452a is a unique or substantially unique identifier for that question from the body of questions 51. The question ID 452a may be numeric, for example.

The question subject indicator 452b may be a copy of the question of the body of question 51 or may be some other summary of the subject of the question, so that the assessor can readily determine the subject of the question.

The question type 452c may be indicative of the type of question in terms of the nature of the answer requires—e.g. multiple choice, free text, etc.

The question level 452d may be an indicator of the perceived difficulty of the question and/or the level of the question according to some other standard (e.g. certain subject matter may form the part of a syllabus for a particular level of a qualification).

The question media indicator 452e may be an indicator that the question includes media of some form. This media may be an image, a video, a sound, or the like.

The question status indicator 452f is an indicator of the current status of the question in the assessment system 1. This status may be indicative of the point at which the question has reached in the approval process for inclusion in an assessment instance 53, for example.

The question list panel 452 may list a maximum of a pre-determined number of questions of the sub-set or sub-group of the body of questions 51 (or all the questions of the body of questions 51). Therefore, the questions may be spread over a plurality of pages and the assessor may be able to navigate between pages of questions within the question list panel 452. Again, this may be achieved locally, or using sent data to the assessment server 11 and receiving server data with the next page of questions in accordance with a request in the sent data.

The question management interface 45 may include one or more assessor selectable functions 453 which may be performed in relation to the body of questions 51 and/or the organised hierarchy. For example, the one or more assessor selectable functions 453 may include a function to re-organise the hierarchy—e.g. by the creation and/or deletion of topics or subjects 451a and/or by the creation and/or deletion of sub-groups 451b.

The one or more assessor selectable functions 453 may include a function to rename a topic or subject 451a and/or a sub-group 451b.

The one or more assessor selectable functions 453 may include a function to enable the assessor to allocate privileges in association with the body of questions 51 and/or a sub-set of the questions 51 and/or a sub-group for the questions 51 and/or individual questions 51. These privileges may be associated with particular users based on their accounts 113b.

In some embodiments, the one or more assessor selectable functions 453 may be configured to send the data generated through their operation to the assessment server 11 which may then edit, update, or otherwise alter the information stored on the storage medium 113 accordingly.

The one or more assessor selectable functions 453 may include one or more functions for changing or filtering the display of information in either or both of the navigation panel 451 and the question list panel 452. The changing or filtering may be achieved locally by the administrator device 13 or may be achieved by the sending of the request, as sent data, to the assessment server 11 which then returns, as served data, the filtered or changed information for display.

The one or more assessor selectable functions 453 may include a function to create a new question for the body of questions 51. In some embodiments, that new question is associated with the selected topic or subject 451a and/or sub-group 451b when the function is selected.

In some embodiments, when the function to create a new question is selected, a new question interface 46 is presented to the assessor via the administrator device 13. Accordingly, the selection of this function may be sent to the assessment server 11, as sent data, which then returns one or more instructions, as served data, which are intended to cause the administrator device 13 to present the new question interface.

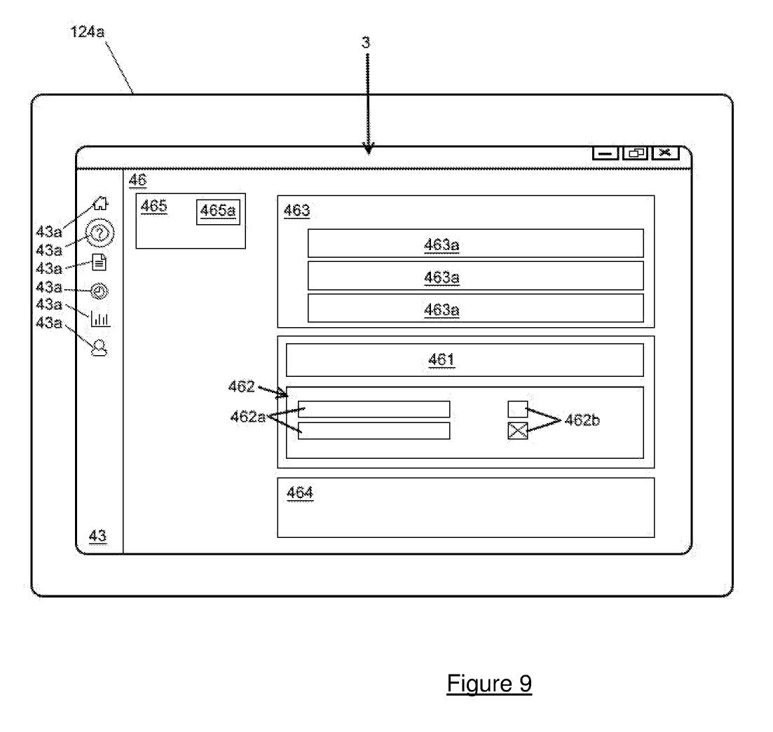

The new question interface 46 may include a plurality of fields and options to enable the question to be defined—see FIG. 9.

In some embodiments the new question interface 46 include a question field 461 in which an assessor may, using the administrator device 13, enter the new question. Typically, therefore, the question field 461 is a field which can accept text. However, in some embodiments, the question field 461 may additionally or alternatively accept the location of an audio file, the location of an image file, or the location of a video file. On the creation of the new question, the location of the image, and/or audio, and/or video file or files may be accessed by the administrator device 13 and the image and/or audio and/or video file may be uploaded as sent data to the assessment server 11. In some embodiments, the location is sent in the sent data and the assessment sever 11 may obtain the image and/or audio and/or video file. In some embodiments, the location is stored by the assessment server 11 and the image and/or video and/or audio file is retrieved by the assessment device 13 when the question is presented—see below.

As described above, the inclusion of an image, audio or video, within the question is the inclusion of media in the question.

The new question interface 46 includes at least one answer field 462 in which the assessor may, using the administrator device 13, enter the actual correct answer to the new question. In the case of a multiple choice question, the answer field 462 may include a plurality of sub-fields 462a, each sub-field 462a being configured to receive a potential answer input by the assessor in the same manner. In such instances each of the sub-fields 462a may be associated with a correct answer indicator 462b, such as, a tick box which is configured to allow the assessor, using the administrator device 13, to indicate which of the sub-fields 462a include the actual correct answer to the new question. Of course, there may be several correct answers and the correct answer indicators 462b may indicate this accordingly.

In some embodiments, the new question interface 46 may include a settings field 463. The settings field 463 may include one or more sub-fields 463a which may include at least one automatically populated sub-fields and/or at least one manually populated sub-field which is configured to received assessor input, via the administrator device 13.

The one or more automatically populated sub-fields, of provided, may include data which has been served by the assessment server 11, e.g. as served data. This data may include, for example, a question identifier or ID. The question ID may be unique or substantially unique to that question.

The one or more sub-fields 463a of the settings field 463 may include one or more of, for example, a descriptor for the question, a difficulty level for the question, a type of question (e.g. multiple choice), the location of the question within the organised hierarchy of the body of questions 51, and layout information for the question (which may determine how the question is presented to the candidate).

The one or more sub-fields 463a of the settings field 463 may include an option to exclude a combination of that question with another question in the same assessment instance 53. That other question may be selected using the one or more sub-fields 463a by the entering of an identifier for that question (such as the relevant question ID 452a). In some embodiments, the other question is a version of the same question and so there may be, for example, a tick box option to indicate that two versions of the same question should not be used in the same assessment instance 53. In some embodiments, a particular question may provide an answer to another question. Therefore, there may be a desire to exclude both such questions appearing in the same assessment instance 53. The one or more sub-fields 463a can be used, as described above, to enable such an exclusion.

The new question interface 46 may further include a reference and comments field 464 which is configured to receive input from the assessor, e.g. via the administrator device 13, which can include comments for those reviewing the question at a later date (e.g. via the new question interface 46). The reference and comments field 464 may also be configured to receive input from the assessor, e.g. via the administrator device 13, which can include an assessor reference for the question—to assist in identification of the question by the assessor at a later time.

Once data has been entered into the new question interface 46 in relation to the new question, then that data may be sent, as sent data, to the assessment server 11 for storage on the storage medium 113—e.g. as a stored question 113f of the body of questions 51.

The new question interface 46 may include a question status indicator 465. The question status indicator 465 is configured to present information about the status of the question. This may include, for example, the author of the question (i.e. the assessor who created the question), the date and/or time of creation, and the like. The presented information may include an approval status for the question. In this regard, a particular assessor may have privileges (e.g. as set through the privilege management interface 42) to author new questions but may not, in some embodiments, have privileges to approve a question for use in generating an assessment instance 53. Accordingly, another assessor with the relevant privileges may need to review and approve the question before it is made available for inclusion in an assessment instance 53.

A question may be approved via the new question interface 46, for example. The new question interface 46 may, therefore, include an approval element 465a. The approval element 465a may be provided as part of the question status indicator 465. The approval element 465a may be selected by an assessor, e.g. via the administrator device 13, in order to allow that assessor to approve the question. On selection of the approval element 465a, account information associated with that assessor may be appended to the stored question 113f to indicate their approval of the question. This may include, for example, a digital signature. The approval may also cause the storing of the date and/or time of approval.

A question may have a plurality of different versions. That is, for example, a single question associated with a common question ID may have more than one version of that question within the body of questions 51 and/or stored on the storage medium 113 associated with the assessment server 11.

A version may be a modified version of the same question—i.e. the question may seek the same answer but one or more aspects of the question may be different in one version of the question compared to another. This may include, for example, the language used in the question, the number or type of answer options in a multiple choice question, or the like.

The version number of a question may be presented in the new question interface 46—e.g. in the question status indicator 465. Approval may be provided, via the approval element 465a, for a particular version of the question (by which it is meant that different assessors may approve different versions of the same question and/or at least one version of a particular question may have approval whilst another version of the same question may not have any approval).

In some embodiments, one or more versions of a particular question may be designated by the assessor, using the question status indicator 465 (e.g. via the approval element 465a) as published. In some embodiments, only published versions of a question may be included in an assessment instance 53. In some embodiments, each question can have only one (i.e. a single) published version at any one time.

The information entered into the new question interface 46 may, as will be appreciated, be sent as sent data to the assessment server 11 for storage on the storage medium 113—as a stored question 113h.

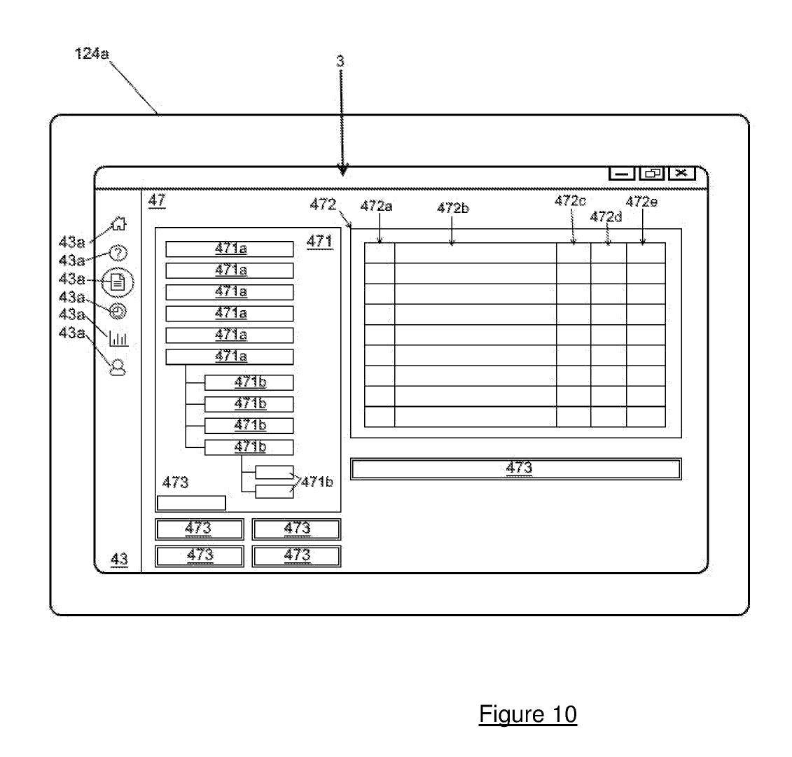

The one or more other user interfaces may include, for example, a template management interface 47—see FIG. 10.

The template management interface 47 is configured to receive template information from the assessor via the administrator device 13. This template information may set out one or more of the assessment templates 52 for an assessment 5 and may be used by the assessment server 11 to generate an assessment instance 53 from the body of questions 51. Accordingly, the template information may specify one or more characteristics or parameters which are to constrain or otherwise define the assessment instance 53 which is to be generated.

The template management interface 47 may be configured to present a template navigation panel 471 for one or more assessment templates 52 (each assessment template 52 being associated with its own template information). The template navigation panel 471 may present the assessment template or templates 52 in accordance with an organised hierarchy—much like the bank of questions 51. The organised hierarchy may be arranged in accordance with any number of suitable configurations so as to achieve straightforward navigation and selection of the assessment templates 52.

For example, the assessment templates 52 (in relation to embodiments including a plurality of assessment templates 52) may be separated according to a particular course, module, or assessor (or other category) such that there is a plurality of categories 471a listed in the template navigation panel 471. The selection by the assessor via the administrator device 13 of one of the plurality of categories 471a may cause the presentation of a sub-set of the assessment templates 52 which are associated with that category 471a in a template list panel 472. This may be achieved locally by the administrator device 13 identifying the sub-set from the assessment templates 52 wherein the assessment server 11 has sent the assessment templates 52 to the administrator device 13. In other embodiments, the assessment templates 52 are held by the assessment server 11 and the selection of one of the plurality of categories 471a is sent, as sent data, to the assessment server 11 which returns the sub-set of assessment templates 52 to the administrator device 13 for presentation in the template list panel 472.

In some embodiments, the plurality of categories 471a is further divided into one or more sub-categories 471b. The selection by the assessor of one of the plurality of categories 471a may cause the presentation in the template navigation panel 471 of one or more sub-categories 471b. In turn, the selection of one of the one or more sub-categories 471b may cause the presentation of an associated sub-category of the sub-set of the assessment templates 52 in the template list panel 472. Again, this may be performed locally or in the assessment server 11.

The organised hierarchy may include more levels—i.e. there may be sub-categories of sub-categories, for example—with the template navigation panel 471 allowing for navigation through the hierarchy and the presentation of the associated assessment templates 52 in the template list panel 472.

The sub-categories may, for example, be more specific topics or subjects, or may be different difficult levels, or different test lengths (in terms of question number and/or time), for example.

The template navigation panel 471 may be configured to present the one or more categories 471a and, if applicable, the one or more sub-categories 471b in a tree-like navigation structure. The assessor may, therefore, via the administrator device 13 may able to expand and collapse parts of the presented hierarchy to show or hide parts thereof.

The template list panel 472 may present a summary of the details of the relevant assessment template or templates 52 depending on the selection made in the template navigation panel 471.

The summary details may include one or more of a template identifier 472a (i.e. a template ID), a template subject indicator 472b, a time allowed indicator 472c, a pass mark 472d, and a template status indicator 452e.

The template ID 472a is a unique or substantially unique identifier for that assessment template 52. The template ID 472a may be numeric, for example.

The template subject indicator 472b may be a title or some other summary of the subject of the assessment template 52, so that the assessor can readily determine the subject of the assessment template 52.

The time allowed indicator 472c may be indicative of the total time allowed for the sitting of an assessment instance 53 generated using that assessment template 52. In some embodiments, this indicator 472c is, instead, a total question number indicator—indicating the total number of questions in an assessment instance 53 created using the assessment template 52.

The pass mark 472d may be an indicator of the mark which a candidate must achieve in an assessment instance 53 generated using that assessment template 52 to be deemed to be a pass. This may be expressed in terms of the number of questions which must be correct, a total number of marks which must be achieved, and/or a proportion of the total number of questions or marks which must be achieved (which may be expressed as a percentage, for example).

The template status indicator 472e is an indicator of the current status of the assessment template 52 in the assessment system 1. This status may be indicative of the point at which the template 52 has reached in the approval process for use in generating an assessment instance 53, for example.

The template list panel 472 may list a maximum of a pre-determined number of assessment templates 52 of the sub-set or sub-group of the assessment templates 52 (or all the assessment templates 52). Therefore, the questions may be spread over a plurality of pages and the assessor may be able to navigate between pages of questions within the template list panel 472. Again, this may be achieved locally, or using sent data to the assessment server 11 and receiving server data with the next page of assessment templates 52 in accordance with a request in the sent data.

The template management interface 47 may include one or more assessor selectable functions 473 which may be performed in relation to the assessor templates 52 and/or the organised hierarchy. For example, the one or more assessor selectable functions 473 may include a function to re-organise the hierarchy—e.g. by the creation and/or deletion of categories 471a and/or by the creation and/or deletion of sub-categories 471b.

The one or more assessor selectable functions 473 may include a function to rename a category 471a and/or a sub-category 471b.

The one or more assessor selectable functions 473 may include a function to enable the assessor to allocate privileges in association with the assessment templates 52 and/or a sub-set of the assessment templates 52 and/or a sub-category for the assessment templates 52 and/or individual assessment templates 52. These privileges may be associated with particular users based on their accounts 113b.

In some embodiments, the one or more assessor selectable functions 473 may be configured to send the data generated through their operation to the assessment server 11 which may then edit, update, or otherwise alter the information stored on the storage medium 113 accordingly.

The one or more assessor selectable functions 473 may include one or more functions for changing or filtering the display of information in either or both of the template navigation panel 471 and the template list panel 472. The changing or filtering may be achieved locally by the administrator device 13 or may be achieved by the sending of the request, as sent data, to the assessment server 11 which then returns, as served data, the filtered or changed information for display.

The one or more assessor selectable functions 473 may include a function to create a new assessment template 52. In some embodiments, that new assessment template 52 is associated with the selected topic or subject 471a and/or sub-group 471b when the function is selected.

In some embodiments, when the function to create a new assessment template is selected, a new template interface 48 is presented to the assessor via the administrator device 13. Accordingly, the selection of this function may be sent to the assessment server 11, as sent data, which then returns one or more instructions, as served data, which are intended to cause the administrator device 13 to present the new template interface 48.

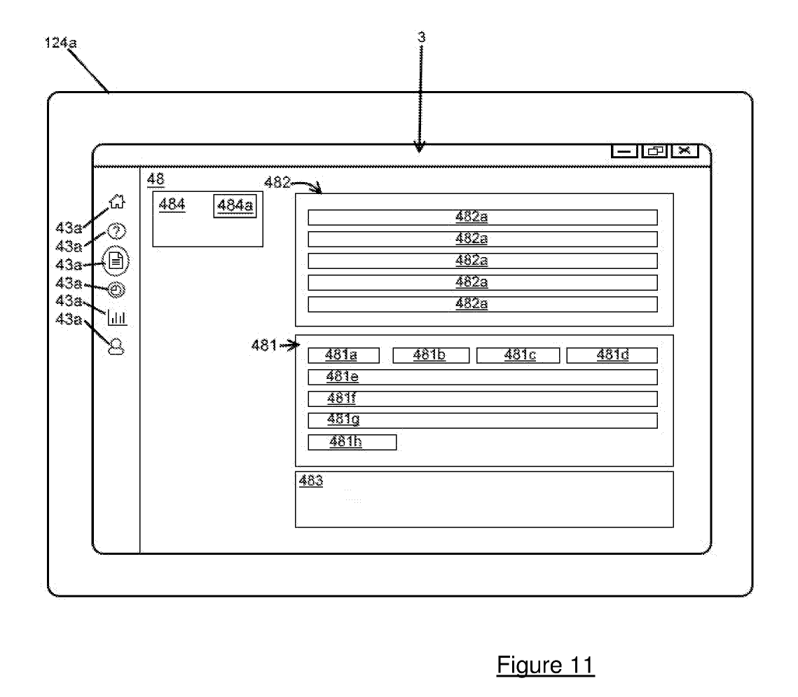

The new template interface 48 may include a plurality of fields and options to enable the assessment template 52 to be defined—see FIG. 11.

In some embodiments the new template interface 48 include an assessment content field 481 in which an assessor may, using the administrator device 13, enter details of the content of a new assessment 5 (to be used when generating an assessment instance 53).

Therefore, the assessment content field 481 may include a question source sub-field 481a. The assessment source sub-field 481a allows the assessor to enter the source of the questions which are to form part of an assessment instance 53.

Accordingly, the assessment source sub-field 481a may be configured to receive the selection of a sub-set of the questions of the body of questions 51 (which may be all of the body of questions 51 in some examples). This may be achieved by the selection of one or more topics or subjects 451a and/or one or more sub-groups 451b. This selection may be achieved in any suitable manner—e.g. via a drop-down menu.

The assessment content field 481 may include a question type sub-field 481b. The question type sub-field 481b may be associated with the assessment source sub-field 481a and may define a type of question for inclusion, from the indicated sub-set of the body of questions 51, for inclusion in an assessment instance 53. Thus, the assessor may use the question type sub-field 481b to select multiple choice questions, or a particular level of question, for example. The question type sub-field 481b may be based on any information which is stored in relation to the questions in the body of questions 51.

The assessment content field 481 may include a question number sub-field 481c. The question number sub-field 481c may be configured to receive an indication of one or more of a maximum, minimum, and total number of questions which can be taken from the sub-set of questions indicated by the assessment source sub-field 481a. Accordingly, the assessment source sub-field 481a and the question number sub-field 481c may be associated with each other.

In some embodiments, the assessment content field 481 may include one or more further assessment source sub fields 481a (each of which may be associated with its own question type sub-field 481b and/or question number sub-field 481c).

The assessment content field 481 may further include one or more of a time allowed field 481d, a total questions field 481e, a pass mark field 418f, and one or more other fields 481g.

The time allowed field 481d may be configured to receive, from the assessor via the administrative device 13, the total time allowed for the candidate to sit the assessment instance 53.

The total questions field 481e may be configured to receive, from the assessor via the administrative device 13, the total number of questions allowed in an assessment instance 53.

The pass mark field 418f may be configured to receive, from the assessor via the administrative device 13, the pass mark for the assessment instance(s). This mark may be defined in terms of, for example, any of: the number of questions which need to be correct, the total number of marks of the correctly answered questions, and the proportion of correctly answered questions or marks (which may be expressed as a percentage, for example).

The one or more other fields 481g may be configured to receive, from the assessor via the administrative device 13, one or more other parameters or characteristics.

For example, the one or more other fields 481g may include a field to indicate whether the order of the questions in the assessment instance 53 should be randomised (i.e. shuffled in a random or pseudo-random manner), the order of the answers in multiple choice questions should also or alternatively be so randomised, backwards and forwards navigation through a series of questions should be permitted (or only forwards navigation), any of the questions should be timed individually (in addition to or instead of the entire assessment sitting), negative marking should be used (i.e. where an incorrect answer by a candidate results in a deduction of marks), and the marking of any of the answers should be weighted in relation to the marks allocated.

The one or more other fields 481g may be selectable via respective tick-boxes or the like.

The new template interface 48 may include an end of assessment options field 481h using which options of the end of the assessment may be selected or otherwise defined. For example, this field may be used to define whether or not the candidate is provided with an indication of a pass or a fail, or a mark or percentage or a score, or not.

In some embodiments, the new template interface 48 may include a settings field 482. The settings field 482 may include one or more sub-fields 482a which may include at least one automatically populated sub-fields and/or at least one manually populated sub-field which is configured to received assessor input, via the administrator device 13.

The one or more automatically populated sub-fields, of provided, may include data which has been served by the assessment server 11, e.g. as served data. This data may include, for example, an assessment template identifier or ID. The assessment template ID may be unique or substantially unique to that template.

The one or more sub-fields 482a of the settings field 482 may include one or more of, for example, a descriptor for the assessment template 52, the location of the assessment template 52 within the organised hierarchy of assessment templates 52, and the number of variants of assessment instances 53 are to be generated in accordance with the assessment template 52. In some embodiments, a sub-field for the number of variants of assessment instances 53 which are to be generated in accordance with the assessment template 52 may be provided in the new deployment interface 50 (see below) and may be one of the one or more other fields 505 thereof (again, see below).

If the number of variants is set to one (e.g. by the assessor using the administrator device 13), then all assessment instance 53 generated at one time by the assessment system 1 based on that assessment template 52 will be the same). In some instances, to discourage or hinder cheating by candidates, multiple variants may be generated.

The new template interface 48 may further include a reference and comments field 483 which is configured to receive input from the assessor, e.g. via the administrator device 13, which can include comments for those reviewing the template 52 at a later date (e.g. via the new template interface 48). The reference and comments field 483 may also be configured to receive input from the assessor, e.g. via the administrator device 13, which can include an assessor reference for the template 52—to assist in identification of the template 52 by the assessor at a later time.

Once data has been entered into the new template interface 48 in relation to the new assessment template 52, then that data may be sent, as sent data, to the assessment server 11 for storage on the storage medium 113—e.g. as a stored template 113g.

The new template interface 48 may include a template status indicator 484. The template status indicator 484 is configured to present information about the status of the assessment template 52. This may include, for example, the author of the template 52 (i.e. the assessor who created the assessment template 52), the date and/or time of creation, and the like. The presented information may include an approval status for the template 52. In this regard, a particular assessor may have privileges (e.g. as set through the privilege management interface 42) to author new assessment templates 52 but may not, in some embodiments, have privileges to approve a template 52 for use in generating an assessment instance 53. Accordingly, another assessor with the relevant privileges may need to review and approve the template 52 before it is made available for inclusion in an assessment instance 53.

An assessment template 52 may be approved via the new template interface 48, for example. The new template interface 48 may, therefore, include a template approval element 484a. The template approval element 484a may be provided as part of the template status indicator 484. The template approval element 484a may be selected by an assessor, e.g. via the administrator device 13, in order to allow that assessor to approve the assessment template 52. On selection of the template approval element 484a, account information associated with that assessor may be appended to the stored assessment template 113g to indicate their approval of the template 52. This may include, for example, a digital signature. The approval may also cause the storing of the date and/or time of approval.

An assessment template 52 may have a plurality of different versions. That is, for example, a single template 52 associated with a common template ID may have more than one version of that template 52 stored on the storage medium 113 associated with the assessment server 11.

A version may be modified version of the same assessment template 52—i.e. two versions of the template 52 may be largely the same but one version may be updated into include a different pass mark.

The version number of an assessment template may be presented in the new template interface 48—e.g. in the template status indicator 484. Approval may be provided, via the template approval element 484a, for a particular version of the template 52 (by which it is meant that different assessors may approve different versions of the same template 52 and/or at least one version of a particular template 52 may have approval whilst another version of the same template 52 may not have any approval).

In some embodiments, one or more versions of a particular assessment template 52 may be designated by the assessor, using the template status indicator 484 (e.g. via the approval element 484a) as published. In some embodiments, only published versions of a template 52 may be used to generate an assessment instance 53. In some embodiments, each template 52 can have only one (i.e. a single) published version at any one time.

The information entered into the new template interface 48 may, as will be appreciated, be sent as sent data to the assessment server 11 for storage on the storage medium 113—as a stored template 113g.

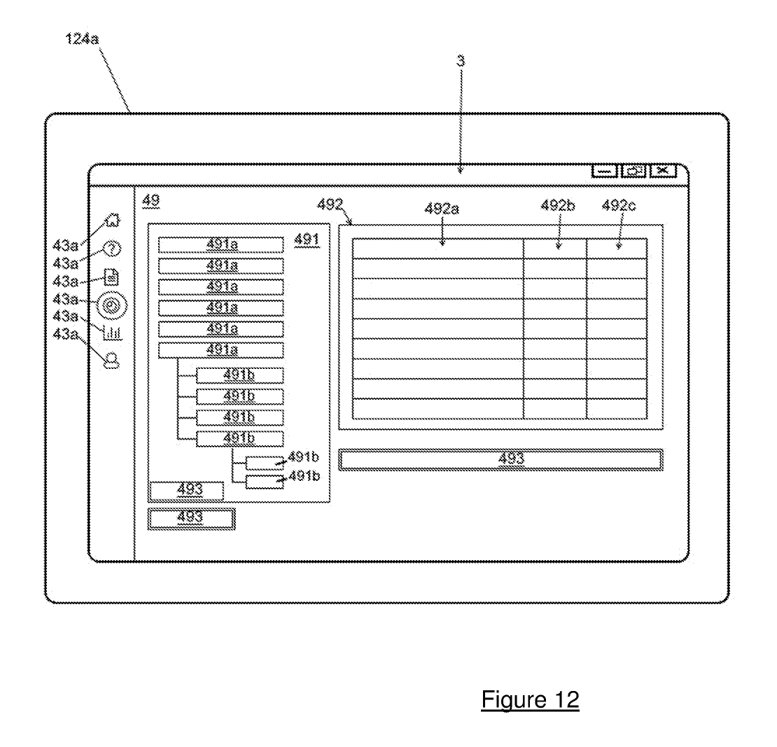

The one or more other user interfaces may include, for example, a deployment management interface 49—see FIG. 12.

The deployment management interface 49 is configured to receive deployment information from the assessor via the administrator device 13. This deployment information may set out one or more deployments of an assessment 5 and may be used by the assessment server 11 to generate an assessment instance 53 from the body of questions 51 using one of the one or more assessment templates 52. Accordingly, the deployment information may specify one or more deployment instructions for the assessment instance 53 which is to be generated.

The deployment management interface 49 may be configured to present a deployment navigation panel 491 for one or more assessment deployments. The deployment navigation panel 491 may present the assessment deployments in accordance with an organised hierarchy—much like the bank of questions 51. The organised hierarchy may be arranged in accordance with any number of suitable configurations so as to achieve straightforward navigation and selection of assessment deployments.

For example, the assessment deployments (in relation to embodiments including a plurality of assessment deployments) may be separated according to a particular course, module, or assessor (or other category) such that there is a plurality of deployments listings 491a listed in the deployment navigation panel 491. The selection by the assessor via the administrator device 13 of one of the plurality of listings 491a may cause the presentation of a sub-set of the assessment deployments which are associated with that listing 491a in a deployment list panel 492. This may be achieved locally by the administrator device 13 identifying the sub-set from the assessment deployments wherein the assessment server 11 has sent the assessment deployments to the administrator device 13. In other embodiments, the assessment deployments are held by the assessment server 11 and the selection of one of the plurality of listings 491a is sent, as sent data, to the assessment server 11 which returns the sub-set of assessment deployments to the administrator device 13 for presentation in the deployment list panel 492.

In some embodiments, the plurality of listings 491a is further divided into one or more sub-listings 491b. The selection by the assessor of one of the plurality of listings 491a may cause the presentation in the deployment navigation panel 491 of one or more sub-listings 491b. In turn, the selection of one of the one or more sub-listings 491b may cause the presentation of an associated sub-listing of the sub-set of the assessment deployments in the deployment list panel 492. Again, this may be performed locally or in the assessment server 11.

In some embodiments, each of the one or more sub-listings 491b may be further divided into one or more sub-listings 491b of its own.

The organised hierarchy may include more levels—i.e. there may be sub-listings of sub-listings, for example—with the deployment navigation panel 491 allowing for navigation through the hierarchy and the presentation of the associated assessment deployments in the deployment list panel 492.

The sub-listings may, for example, be more specific topics or subjects, or may be different difficult levels, or different test lengths (in terms of question number and/or time), or may be used to distinguish between other groups of different deployments, or may be used to distinguish between deployments made at different times (e.g. different dates or years), or may distinguish between deployments for different groups of candidate, for example.

The deployment navigation panel 491 may be configured to present the one or more listings 491a and, if applicable, the one or more sub-listings 491b in a tree-like navigation structure. The assessor may, therefore, via the administrator device 13 may able to expand and collapse parts of the presented hierarchy to show or hide parts thereof.

The deployment list panel 492 may present a summary of the details of the relevant assessment deployment(s) depending on the selection made in the deployment navigation panel 491.

The summary details may include one or more of a deployment identifier 492a (i.e. a deployment ID), an assessment start time 492b, and an assessment end time 492c.

The deployment ID 492a is a unique or substantially unique identifier for that assessment deployment. The deployment ID 492a may be numeric, for example.

The assessment start time 492b and the assessment end time 492c may specify, respectively, the time and/or date on which the assessment instances 53 for that deployment will start and stop (i.e. when the assessment instances 53 will be available to be sat).

The deployment list panel 492 may list a maximum of a pre-determined number of assessment deployments of the sub-set or sub-group of the assessment deployments (or all the assessment deployments). Therefore, the questions may be spread over a plurality of pages and the assessor may be able to navigate between pages of questions within the deployment list panel 492. Again, this may be achieved locally, or using sent data to the assessment server 11 and receiving server data with the next page of assessment deployments in accordance with a request in the sent data.

The deployment management interface 49 may include one or more assessor selectable functions 493 which may be performed in relation to the assessor templates 52 and/or the organised hierarchy. For example, the one or more assessor selectable functions 493 may include a function to re-organise the hierarchy—e.g. by the creation and/or deletion of listings 491a and/or by the creation and/or deletion of sub-listings 491b.

The one or more assessor selectable functions 493 may include a function to create a new deployment. In some embodiments, that new deployment is associated with the selected listing 491a and/or sub-listing 491b when the function is selected.

In some embodiments, when the function to create a new deployment is selected, a new deployment interface 50 is presented to the assessor via the administrator device 13. Accordingly, the selection of this function may be sent to the assessment server 11, as sent data, which then returns one or more instructions, as served data, which are intended to cause the administrator device 13 to present the new deployment interface 50.

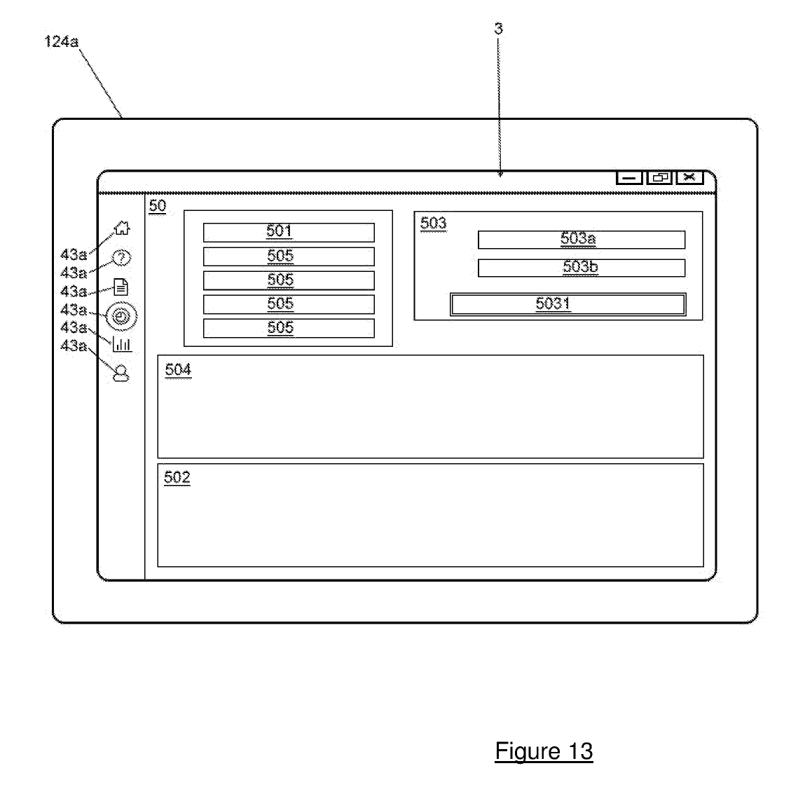

The new deployment interface 50 may include a plurality of fields and options to enable the deployment to be created—see FIG. 13.

As will be understood from the description herein, an assessment template 52 is a template for an assessment 5 and sets out various characteristics and parameters for the assessment 5. That assessment template 52 calls upon the body of questions 51 (or a sub-set thereof) in order to populate an assessment instance 53. In some embodiments, the assessment template 52 calls upon only published versions of the questions in the body of questions 51. An assessment instance 53 is an assessment (i.e. a test) which is generated by the assessment system 1 and presented to a candidate for them to sit. A deployment may, therefore, be a definition of the assessment instance 53 which uses an assessment template 52 to generate at least one assessment instance 53. A particular deployment may generate a plurality of assessment instances 53 and each candidate may be presented with one such assessment instance 53. As will be understood, in a particular deployment, there may be more than one variant of the assessment instances 53. This may discourage copying, for example, because two candidates may not be sitting the same variant even if, for example, sat next to each other.

In some embodiments, all candidates sitting a particular assessment may be presented with the same assessment instance 53, or sub-sets of the candidates may each be presented with the same respective assessment instance 53, or each candidate may be presented with a different respective assessment instance 53.

A deployment, therefore, may define which assessment template 52 is to be used in the generation of the or each assessment instance 53. For the avoidance of doubt, in the situation in which there is a plurality of candidates for a particular assessment, all of the assessment instances 53 may be defined by the same assessment template 52. The deployment may define which candidates are to sit the assessment. Likewise, the deployment may define which candidates are to sit which assessment instance 53 of the assessment.

Accordingly, the new deployment interface 50 may include an assessment template selection field 501 which is configured to receive the assessor's selection of one of the one or more assessment templates 52. This may be achieved by the use of any suitable interface element, such as a drop-down menu, for example. In some embodiments, only published versions of the assessment templates 52 can be selected.

The new deployment interface 50 may include a candidate list 502 which is configured to receive the assessor's selection of one or more candidates to whom assessment instances 53 are to be deployed. Again, this may be achieved in any suitable manner such as via an address book or drop-down menu. In some embodiments, the candidate or candidates may be identified or selected based on the account information 113a held for the accounts 113b associated with the candidates. Therefore, the new deployment interface 50 may send, as sent data, one or more requests to the assessment server 11 for this account information 113a so that the relevant candidates can be added to the candidate list 502. In some embodiments, groups of candidates can be added using the information stored regarding the groups of accounts 113c.

The candidate list 502 may also list other information in relation to each candidate. For example, the name of the or each candidate may be listed (as extracted, for example, from the account information 113a), and/or the variant of the assessment 5 which the or each candidate is sitting may be listed, and/or the score or mark the or each candidate has achieved may be listed, and/or whether the or each candidate has passed or failed may be listed. Accordingly, as will be appreciated, the candidate list 502 may be periodically updated from the assessment server 11 (i.e. new served data is received during the assessment).

The new deployment interface 50 may include an assessment availability field 503 which is configured to receive one more of the assessment start time 492b in a corresponding sub-field 503a, the assessment end time 492c in a corresponding sub-field 503b, and the duration of the assessment. The assessor may enter this information in any suitable manner.

In some embodiments, the assessment availability field 503 may include an assessor trigger option 5031. If this assessor trigger option 5031 is enabled, by selection by the assessor, then the assessment instance(s) 53 may be made available (i.e. launched) when the assessor selects a launch option—which may be provided as part of the assessor trigger option. Accordingly, there may be at least no defined assessment start time 492b in the assessment availability field 503 when this option is selected.

The new deployment interface 50 may include a variant information panel 504 which is configured to present, via the administrator device 13, information about the variant or variants which are being deployed—each in light of their specification in the assessment template 52. This information may indicated, for example, the number of different variants of the assessment 5 the number of candidates sitting each variant, and the like. In some embodiments, the variant information panel 504 includes one or more links (such as hyperlinks) which allow the assessor to view the or each variant of the assessment 5.

The new deployment interface 50 may include one or more other fields 505. These one or more other fields 505 may include one or more of: a deployment name field (to receive the name of the deployment), the location of the deployment in the organised hierarchy, the layout and look of the deployment (e.g. if the layout and look is to match a predetermined template such as a corporate template), introductory text (which may include a rubric for the deployment to be presented to the candidates during or before the assessment takes place), and one or more tags for the deployment (to help to identify the deployment later). Each of these one or more other fields 505 may be configured to receive input from the assessor, e.g. via the administrator device 13, which may then be sent as sent data for storage on the storage medium 113 associated with the assessment server 11.

The one or more tags may be used, for example, in later searching and analysis. As such, the or each tag may specify a particular trainer or candidate location or the like.

As will be appreciated, therefore, the assessment system 1 may be used to deploy one or more assessment instances 53 to respective candidates.

The or each candidate may access the assessment instance 53 via a respective assessment device 12 (of course, two candidates may equally use the same assessment device 12 at different times). Accordingly, the candidate will initiate contact with the assessment server 11 in accordance with some embodiments.

Initiating contact may comprise the assessment device 12 of the candidate sending a request to the assessment server 11. This request may include a request for a login web page, for example—see FIG. 4, for example. The request may be sent through the browser application of the assessment device 12 and may be caused by the candidate entering an address for the assessment server 11 into a field within the browser. For example, the address may be a uniform resource locator (URL) or IP address or other network address for the assessment server 11. The request, therefore, is an example of sent data.

Authentication may take place in the same manner as for the assessor, as described above in relation to FIG. 4.

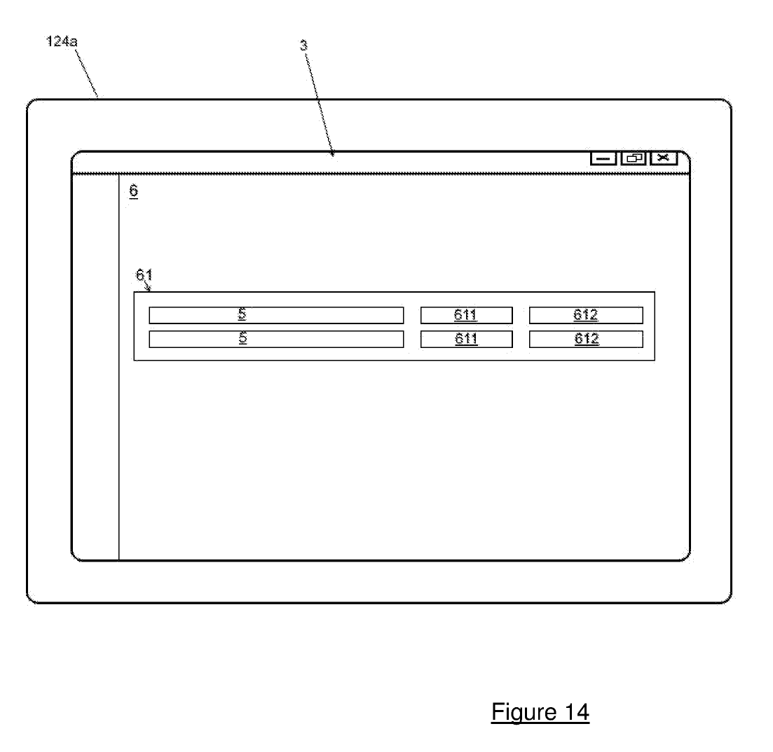

In response to authentication of the candidate, the assessment server 11 may be configured to send served data to the assessment device 12 which is intended to cause the assessment device 12 to present an assessment selection interface 6 to the candidate—see FIG. 14, for example. That data, another example of served data, may include one or more web pages, for example, and may be received as received served data by the assessment device 12.

The assessment selection interface 6 may, for example, list one or more assessments 5 for which the candidate is listed as a candidate in the relevant candidate list 502 (see above) for a deployed assessment. The one or more assessments 5 may be listed in a candidate assessment list 61 of the assessment selection interface 6.

The candidate assessment list 61 may, of course, list no assessments 5 if that candidate does not appear in any of the candidate lists 502 for deployed assessments.

The candidate assessment list 61 may indicate the assessment 5 with an identifier such as the deployment identifier 492a or other descriptor for the assessment template 52 or assessment 5.

The candidate assessment list 61 may also indicate whether the assessment 5 is available to be sat by the candidate with an availability indicator 611. The availability indicator 611 may state whether the assessment 5 is available to be sat, and/or when the assessment 5 will be available to be sat, and/or when the assessment 5 will no longer be available to be sat, and/or how long the assessment 5 will remain available to be sat. This information may be obtained from the assessment availability field 503 as completed by the assessor, in some embodiments, in the new deployment interface 50.

The candidate assessment list 61 may include a start option 612 which is selectable by the candidate to commence the assessment 5—e.g. in the form of a button.

On selection of the start option 612, the assessment device 12 is configured to send a request, as sent data, for the assessment 5 to the assessment server 11. The assessment server 11 will, in response, identify the assessment instance 53 which that candidate is to be sent and will deliver, as served data, the assessment instance 53.

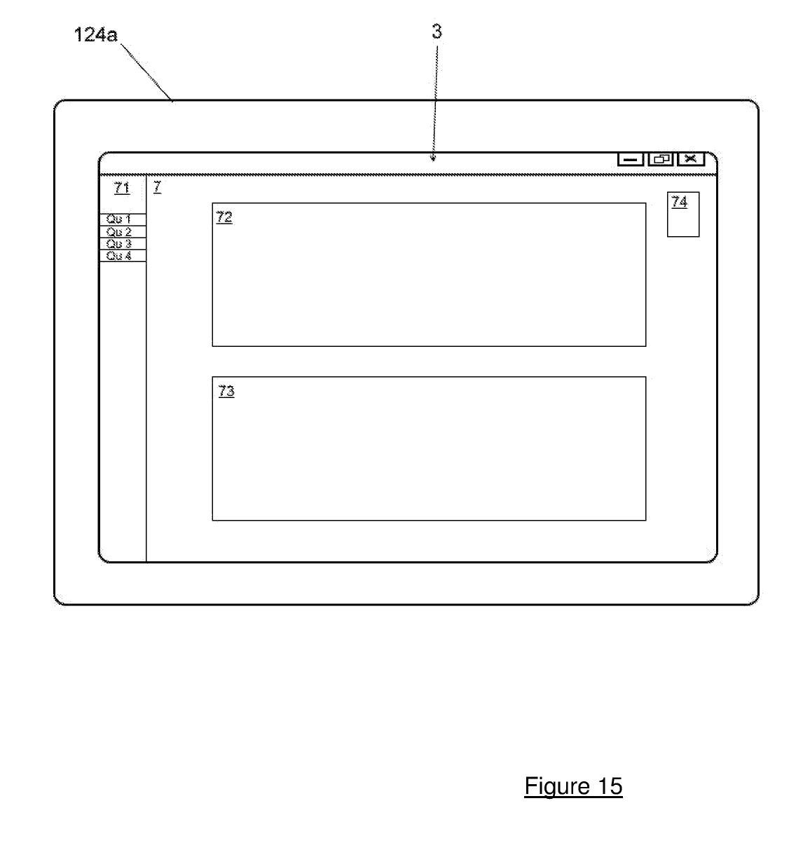

The assessment instance 53 may then be presented to the candidate via their assessment device 12 through an assessment interface 7—see FIG. 15.

The assessment interface 7 may include a question navigation ribbon 71 which may list the questions which form part of the assessment instance 53 (e.g. by number: question 1, question 2, etc. (or “Qu 1”, “Qu 2”, etc., for short).

In some embodiments, the assessor (via the assessment template 52) may have imposed restrictions on the forward and backward navigation through the questions listed in the question navigation ribbon 71. For example, the assessor may have specified that backwards navigation is not to be possible and, as such, once a candidate has viewed a question then that question cannot be viewed again. In some embodiments, backwards navigation may be permitted and to so the candidate can move back through questions which they have already viewed. In some embodiments, forward navigation is permitted in the settings determined by the assessor in the assessment template 52 but only one question at a time.

Accordingly, the question navigation ribbon 71 may have different functionality depending on the settings determined by the assessor in the assessment template 52. In some embodiments, therefore, the question navigation ribbon 71 provides an indication of the current question and may provide an indication of the total number of questions but may not allow for navigation between questions.

On selection of a question (either by the candidate via the question navigation ribbon 71 or automatically starting with the first question and moving through the questions as each answer is submitted), the assessment interface 7 may present, via the assessment device 12, a question panel 72. The question panel 72 includes a question (as selected from the body of questions 51 in accordance with the assessment template 52 for that deployment). The question may, as indicated above, include media.

In some embodiments, the question in the question panel 72 is presented for a predetermined period of time (the elapsing of which may be presented to the candidate in the question panel 73) or until the candidate selects an option (presented as part of the question panel 72) to move on. After presentation of the question in the question panel 72, an answer panel 73 may be presented to the candidate as part of the assessment interface 7. The answer panel 73 may include, for example, a field for the candidate to enter their answer. This field may include a field to receive text or may include the selection of answers from a list (e.g. in a multiple choice question) and may include a tick box or the like. In some embodiments, both the question panel 72 and the answer panel 73 are displayed simultaneously so that the candidate is presented with the question and can submit their answer whilst the question is still being presented to them.

The answer panel 73 may include additional information. For example, if the assessor set a specific time in which the question needed to be answered, then an indication of this time elapsing may be presented to the candidate in the answer panel 73. The number of marks available may also be presented to the candidate in the answer panel 73.

In some embodiments, the or each question and/or answer panel 72,73 may include a candidate selectable flag 74. The candidate selectable flag 74 may be set or unset by the candidate, via the assessment device 12, to aid the candidate in planning for responding to the assessment 5. For example, a candidate may review the questions in the assessment instance 53 and set the flags on the questions they intend to answer or which they intend to avoid, or which they intend to answer first. The candidate selectable flag 74 may enable a candidate, therefore, to identify questions from a plurality of questions. In some embodiments, the candidate selectable flag 74 may be included as part of the question navigation ribbon 71.

On completion of the assessment 5, the candidate may submit their answers to the assessment server 11, as sent data, for marking. This may involve, for example, the selection of a send option by the candidate using the assessment interface 7.

In some embodiments, an answer as entered into the answer panel 73 is sent to the assessment server 11, as sent data, for marking once the candidate navigates to another question or the answer panel 72 may include a send option in relation to each answer.

The other fields 505 of the candidate list 502 of the new deployment interface 50 may, as indicated, include information about the mark which the or each candidate has obtained. In some embodiments, this may be updated as new answers are marked by the assessment server 11.

The assessment device 12 may be configured to monitor and/or collect key candidate response information 8, in addition to the answer(s) to the question(s).

This key candidate response information 8 may include, for example, one or more of:
the length of time the candidate took to enter an answer to a question after the question panel was presented (this may be represented by a time taken indicator, for example);
the length of time the candidate was presented with a question before the candidate caused (e.g. through input via the question interface) the presentation of the answer panel;
the number of times a candidate changed their answer (this may be represented by a change indicator, for example);
the length of time between changes to the answer;
the time in the overall assessment in which an answer to a question was changed;
whether a correct answer was changed to an incorrect answer prior to final submission of the answer;
whether an incorrect answer was changed to a correct answer prior to final submission;
an aspect of how the answer was changed (e.g. the degree of the change in relation to questions which allow different degrees of change such as a free text answer question);
the time between inputs by the candidate into the assessment device via its input sub-system;
the order in which the questions were answered;
whether the candidate reviewed a plurality of questions before answering one or more of those questions;
whether the candidate set or unset the candidate selectable flag 74 in relation to any question;
in relation to which questions the candidate set or unset the candidate selectable flag 74;
when the candidate set or unset the candidate selectable flag 74 for one or more questions;
how the candidate's use of the candidate selectable flag 74 corresponded with the questions which were answered or not answered, and/or the order in which the questions were answered; and
one or more movements of a cursor (e.g. under control of a mouse 124e of the assessment device 12) including the location of the cursor in relation to one or both of the question panel 72 and the answer panel 73, and/or the timing of such one or more movements.

A degree of change may include, for example, the number of words or characters changed. In some embodiments, a degree of change include an assessment of the meaning of the change—e.g. insertion of a “not” is a single word, three character, change but has a very significant change to the meaning of a sentence.

The assessment device 12 may be further configured to send the key candidate response information 8 to the assessment server 11 as sent data.

The key candidate response information 8 may be stored in association with the candidate's answers to the assessment 5 on the storage medium 113.

The assessment server 11 may be configured to analyse the key candidate response information 8 in order to determine one or more characteristics about the candidate. The assessment server 11 may perform this analysis in combination with the candidate's answers to the assessment 5.

In some embodiments, the analysis of the key candidate response information 8 and/or the candidate's answers may include a comparison to other similar data collected for one or more other candidates. For example, this comparison may be made with corresponding data collected for all candidates responding each question. This may enable, for example, potentially problematic questions to be identified by the use of relative information. The collected information may be average information such as a mean. A problematic question may be, for example, a question which is ambiguous, ineffective, incorrectly presented, or the like.

Thus, for example, the length of time the candidate took to enter an answer to a question after the question panel was presented may provide an indication of the candidate's confidence in the answer. A short period of time between the presentation of the question panel and the entering of the answer may mean that the candidate is confident in the answer. If the answer is correct then this may mean that the candidate is knowledgeable in relation to the subject matter of the question.

The same effects may also be true based on the length of time the candidate was presented with a question before the candidate caused (e.g. through input via the question interface) the presentation of the answer panel.

If the candidate changed their answer on several occasions, then this may indicate a lack of confidence in the answer, even if the overall time to enter the answer was short.

The length of time which has passed between changes of an answer may help to differentiate, for example, between answer input errors (where the candidate knows the correct answer but enters the wrong answer by accident) and instances in which the candidate is not confident about the answer.

When a candidate changes their answers may provide insight into how the candidate approaches stressful situations, with changes near the end of the assessment potentially indicating a last minute panicked approach with a lack of confidence in their earlier answers.

Information about changes in an answer between correct and incorrect answers can provide information about whether the candidate instinctively knew the correct answer and then over-thought the question and changed the answer, or instinctively identified the wrong answer but was able to identify their own mistake.

The time between inputs by the candidate may provide information as to how long the candidate was considering a question and which parts of the question they concentrated on during the assessment. Similar information may be determined from one or more movements of a cursor.

The order in which questions were answered may provide information as to the manner in which a candidate approaches difficult tasks—e.g. tackling the simpler tasks first before moving onto the harder tasks or concentrating on the harder tasks first to the detriment of the simpler tasks. This may be useful information into the candidate's ability to prioritize tasks.

Similar information may be derived from whether the candidate reviewed the plurality of questions before answering one or more of those questions, whether the candidate set or unset the candidate selectable flag 74 in relation to any question, in relation to which questions the candidate set or unset the candidate selectable flag 74, when the candidate set or unset the candidate selectable flag 74 for one or more questions, and how the candidate's use of the candidate selectable flag 74 corresponded with the questions which were answered or not answered, and/or the order in which the questions were answered.

One or more of the different forms of key candidate response information 8 may be combined in order to derive one or more characteristics of the candidate, such as their confidence and their ability to prioritize successfully in stressful situations. This combining process may include comparison to the same key candidate response information 8 types for one or more other candidates also sitting the same assessment 5 (although not necessarily the same assessment instance 53).

In some embodiments, for example, the total length of time taken to answer the or each question may be used to determine a confidence score for each candidate in relation to the or each question. The confidence scores of a candidate for each question in a plurality of questions may be combined to determine an overall confidence score. The combining may be a sum or an average (such as a mean). The average may be a weighted average, for example. The weighting may be determined based on a weighting parameter associated with each question. The weighting parameter may be determined based on an overall confidence score for that question, which may, in turn, be based on the sum or average confidence scores associated with that question for all candidates or for a group of candidates who sat that question.

The confidence score may be absolute (e.g. a total time to complete all questions or an average time to complete all questions) or may be relative to one or more other candidates also sitting the same assessment 5 (although not necessarily the same assessment instance 53).

The confidence score, in this example, may be combined with information about the number of changes to the answer(s). The combination may be a sum or a weighted sum of a confidence score based on response times and a confidence score based on the number of changes to answers.

Accordingly, the or each candidate for the or each assessment 5 they may sit may be determined to have a particular score based on the answers to the or each question, and may also have a confidence factor based on the key candidate response information 8.

The score may be one or more of an indication of the number of marks obtained by the candidate, the number of questions correctly answered, the proportion of marks obtained by the candidate, and the proportion of questions correctly answered (the proportion may be expressed as a percentage).

In accordance with some embodiments, the assessment server 11 may be configured to generate one or more representations of the results, some such representations are described below.

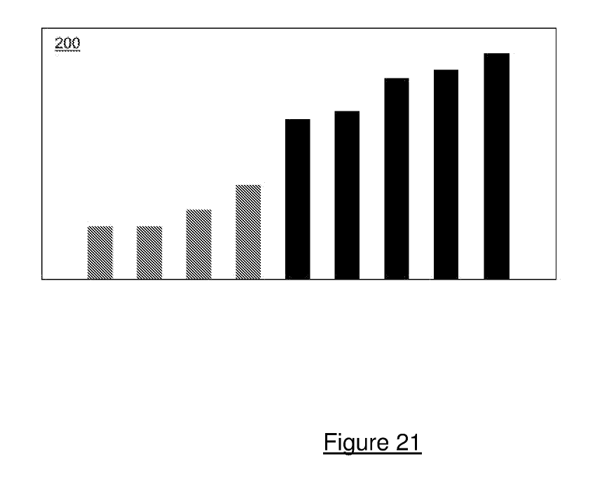

For example, in a first representation 200 (see FIG. 21), the score each of a plurality of candidates obtained who sat the same assessment 5 may be expressed in a bar chart—with one bar for each candidate's score. The bars may be colour coded such that candidate with a score below the pass mark (as indicated in the assessment template 52) has their score represented by a bar which may be a different colour (or shade of the same colour) when compared to the bar or bars representing the score(s) of candidates who achieved more than the pass mark.

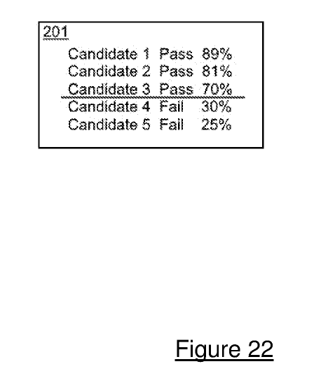

In a second representation 201 (see FIG. 22), a table may be presented with an identifier for each candidate in a first column (with one identifier for each candidate on a separate row of the table)—the identifier may be a candidate name, for example. Another column may present an indication of whether or not the candidate passed or failed. Another column may present the score of each candidate. Another column may present the total length of time taken by the candidate to complete the assessment 5. The candidate identifiers and the associated information may be presented in order of the scores achieved. There may be a line between two of the rows to delineate the one or more candidates who passed from the one or more that failed.

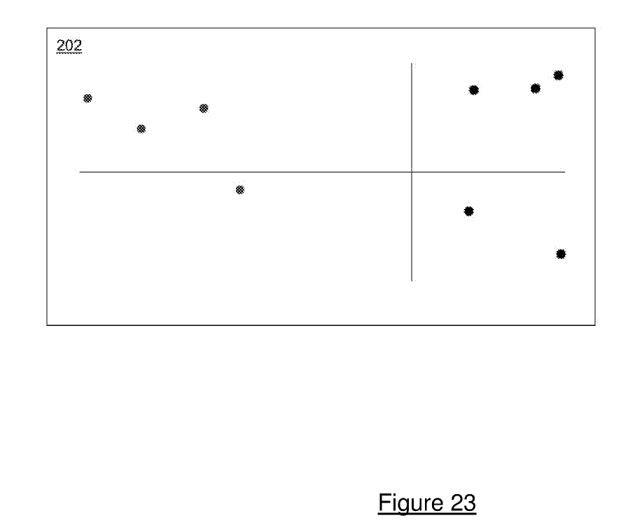

In a third representation 202 (see FIG. 23), a chart may present the score of one or more candidates versus the confidence factor. For example, the score may be represented along an x-axis and the confidence factor along a y-axis. The chart may be separated into four segments by a line representing a score, such as the pass mark, and a line representing a confidence factor. The candidate's scores and confidence factors may be represented on the chart by respective points. In some embodiments, the points (one for each candidate) may be colour coded. For example, candidates with scores above the pass mark may be represented by green points. The shade of green may vary depending on the score. Candidate with scores below the pass mark may be represented by red or orange points, again the shade may vary depending on the score. The points may be presented as circles, squares, triangles, or any other suitable shape.

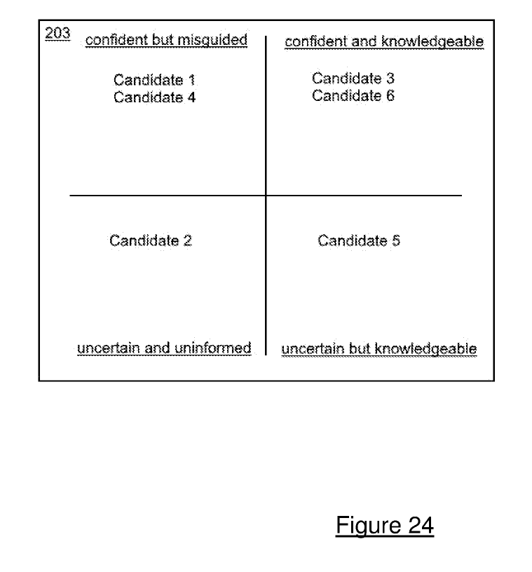

In a fourth representation 203 (see FIG. 24), a table may be presented. The table may be separated into four portions—e.g. by a vertical and an intersecting horizontal line. The names of the candidates may be listed in the relevant portion based on their respective scores and confidence factors. In particular, each portion may represent candidates whose score and confidence factor indicate they were one of: confident but misguided (e.g. due to a high confidence factor but low score), uncertain and uninformed (e.g. due to a low confidence factor and low score), confident and knowledgeable (e.g. due to a high confidence factor and high score), and uncertain but knowledgeable (e.g. due to a high score but low confidence factor).

As will be understood, the first to fourth representations 200-203 may allow candidates to be compared to each other. The use of the confidence factor may provide additional information which may allow better candidates to be selected. The use of the confidence factor may also or alternatively provide information about what training is needed by that candidate (which may be training on the subject matter of the assessment but could also or alternatively be training in building self-confidence, for example).

In some embodiments, the questions (as opposed to the candidates) may be assessed. Accordingly, collated scores and confidence factors for each question, for a plurality of candidates, may be assessed. The collated scores and confidence factors may be averages, such as a mean for example.

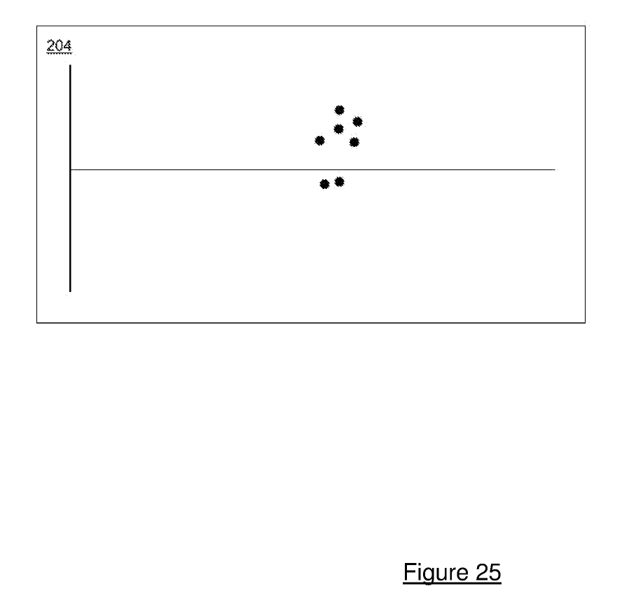

In a fifth representation 204 (see FIG. 25), therefore, a chart may be presented which depicts the collated scores and confidence factors for one or more questions, using the scores and confidence factors from a plurality of candidates. In this representation, the chart may show the collated scores vs the collated confidence factors for the one or more questions. In some examples, the x-axis may represent the collated scores and the y-axis may represent collated confidence factors. Each question may be represented by a point on the chart (which may be presented as a circle, a square, a triangle or any other suitable shape). This chart may allow the or each question to be assessed.

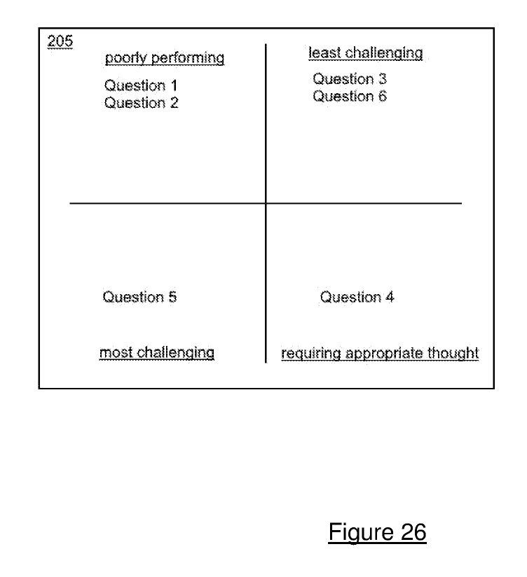

In a sixth representation 205 (see FIG. 26), a table may be presented. The table may be separated into four portions—e.g. by a vertical and an intersecting horizontal line. The questions may be listed in the relevant portion based on their respective collated scores and confidence factors. In particular, each portion may represent questions which are: poorly performing (e.g. due to low scores and high confidence factors), least challenging (e.g. due to high scores and confidence factors), most challenging (due to low scores and low confidence factors), and requiring appropriate thought (due to high scores but low confidence factors).

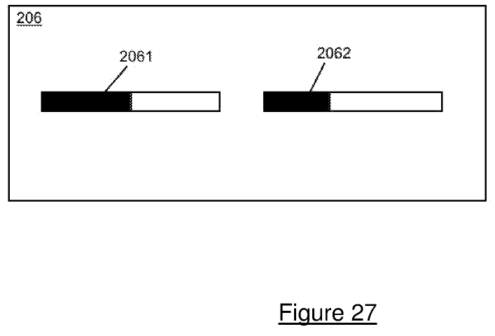

In a seventh representation 206 (see FIG. 27), each question may have a bar 2061 representing the proportion of candidates who answered the question correctly in a particular assessment 5 or assessment instance 53. In addition or alternatively, each question may have a bar 2062 representing the proportion of candidates who answered the question correctly in total, for all occasions in which the question was included in an assessment 5.

In some embodiments, analysis of the number and/or distribution of answers may provide information about whether a particular question is problematic (see above for a discussion on issues with questions which may indicate they are problematic). For example, too many or too few candidates getting the correct answer may provide an indication that the question is too easy or too hard. For the wrong answers entered by candidates, how common those wrong answers were may also provide useful information (i.e. the distribution of wrong answers) such as why the question is being answered incorrectly.

In some embodiments, the performance of individual candidates may be assessed in more detail.

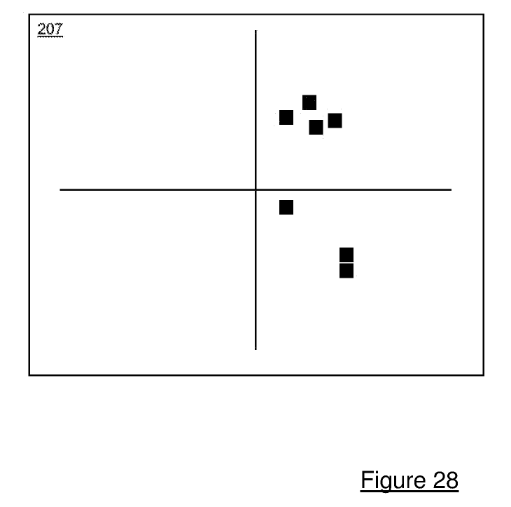

For example, in an eighth representation 207 (see FIG. 28), a chart may present a representation of the confidence factor and the candidate's score relative to a collated score, in relation to each question. The collated score for each question may be an average of the scores for each question in a particular assessment 5 or assessment instance 53 or in all assessments 5 including that question. Each question may be represented on the chart by a point—which may be a shape such as a circle, a square, a triangle, or the like. The points may be colour coded dependent on the confidence factor, for example.

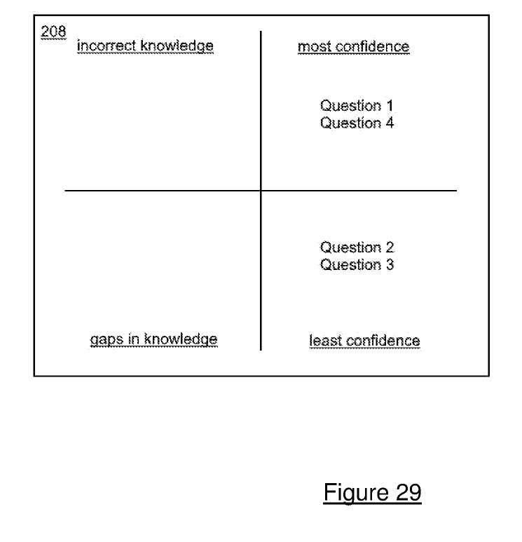

A ninth representation 208 (see FIG. 29) may be in the form of a table separated into four portions—e.g. by a vertical and an intersecting horizontal line. The questions may be listed in the relevant portion based on their associated respective confidence factors and score relative to the collated score. In particular, each portion may represent questions which were, by that candidate answered with: incorrect knowledge (e.g. due to high relative confidence factor and a low relative score), most confidence (e.g. due to high relative confidence factor and a high relative score), gaps in knowledge (e.g. due to low relative confidence factor and a low relative score), and with least confidence (e.g. due to low relative confidence factor and a high relative score). This same form of representation may be used in relation to groups of candidates too.

In some embodiments, a candidate's ability (or the ability of a group of candidates) may be assessed, for example, in relation to topic or subject. As such, the scores and confidence factors for all of the questions relating to a particular subject or topic may be collated—e.g. averaged (which may be a mean).

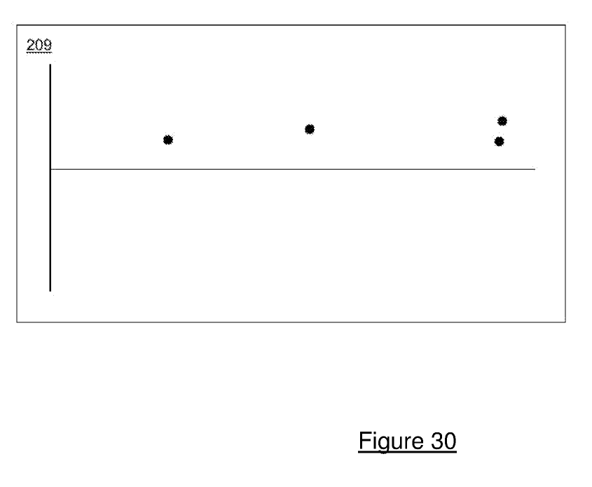

Accordingly, in some embodiments, a tenth representation 209 (see FIG. 30), may present a chart which shows the collated scores and confidence factors for the or each topic or subject. The collated scores may be represented on the x-axis and the collated confidence factors on the y-axis. The or each topic or subject may be represented by a point—which may be a circle, a square, a triangle, or the like. Each point may be colour coded dependent on the collated scores or collated confidence factors.

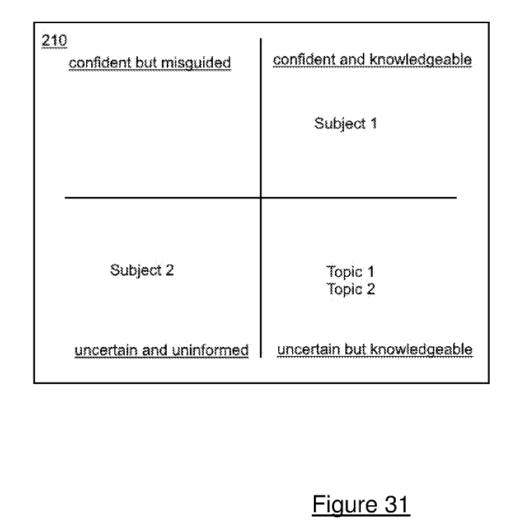

An eleventh representation 210 (see FIG. 31) may be in the form of a table separated into four portions—e.g. by a vertical and an intersecting horizontal line. The topics or subjects may be listed in the relevant portion based on their associated respective collated confidence factors and collated scores. In particular, each portion may represent topics or subjects in relation to which the candidate is: confident but misguided, uncertain and uninformed, confident and knowledgeable, and uncertain but knowledgeable.

In some embodiments, a graphical representation may be provided which shows the time spent on each question by a candidate. This representation may be in the form of a representation similar to a Gantt chart. Accordingly, in a twelfth representation, each question is represented by a row in a chart with the length of the rows representing time. The time spent on each question by a candidate may be represented by a bar. Each bar may be colour coded such that when the candidate selected the correct answer, the bar may be coloured a first colour. In some embodiments, when the candidate selected the wrong answer, the bar may be coloured a second colour.

In some embodiments of this representation, the question and/or answer(s) may be presented adjacent each row.

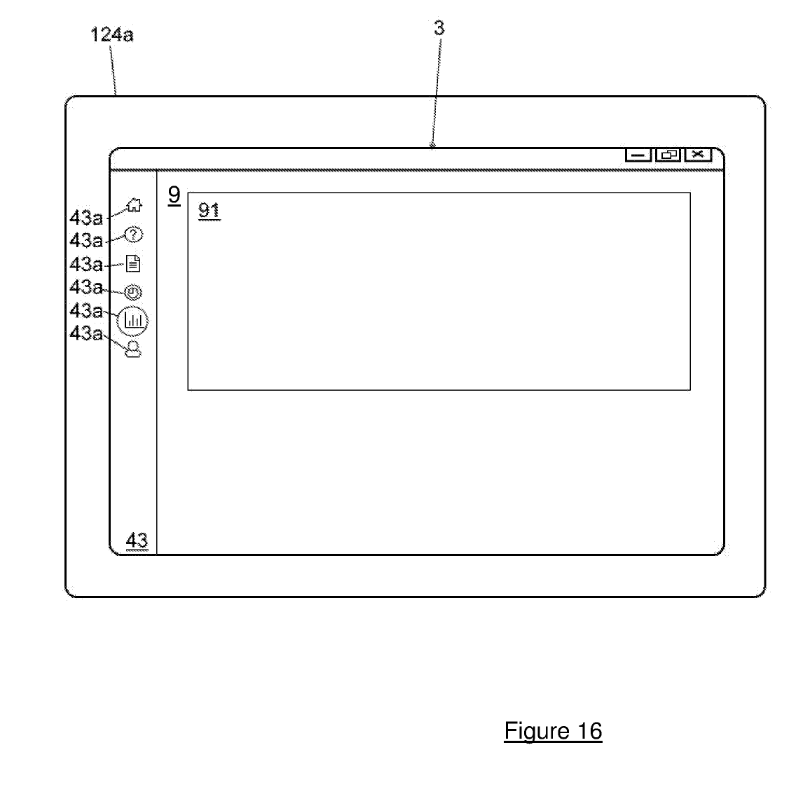

With these and other representations in mind, the one or more other user interfaces may include, for example, a results analysis interface 9—see FIG. 16.

The results analysis interface 9 is configured to receive results information from the assessment server 11 and to present one or more representations of that results information.

Accordingly, the results analysis interface 9 may include a representation panel 91 which is configured to present, to the assessor via the administrator device 13, one or more representations of the results. This may include any one or more of the representations discussed herein, for example.

The representation panel 91 may be configured to present results for a particular candidate in relation to a particular assessment 5 or question. The representation panel 91 may be configured to present results for a particular question based on the answers from a plurality of candidates. That plurality of candidates may be all candidates in a particular group, all candidates who sat a particular assessment 5, all candidates who sat a particular assessment instance 53, all candidates on a particular course or taught by a particular trainer (who may be the assessor, for example), or the like.

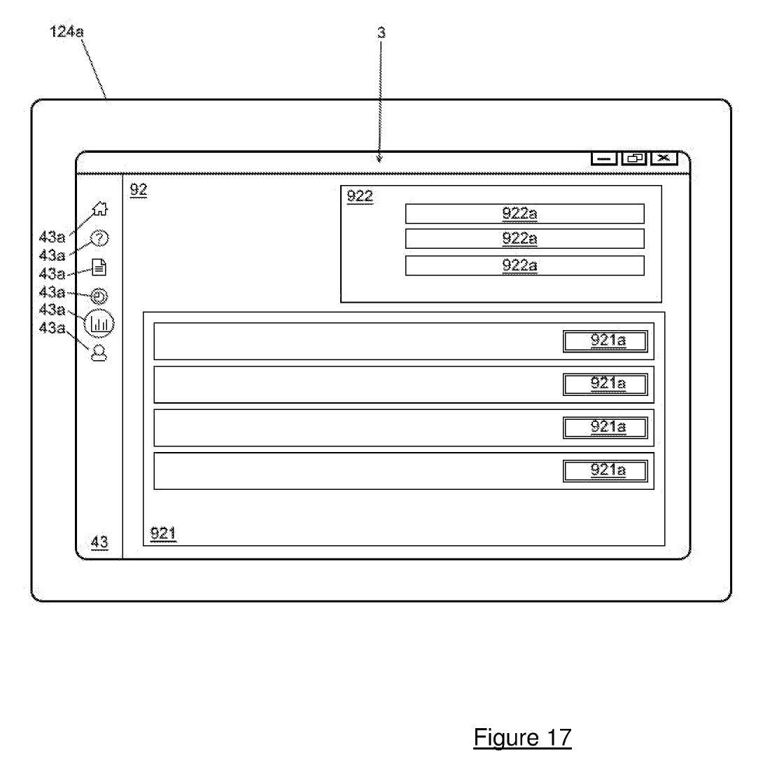

The one or more other user interfaces may include, for example, a results overview interface 92—see FIG. 17.

The results overview interface 92 is configured to receive results information from the assessment server 11 and to present one or more summaries of that results information.

As such, the results overview interface 92 may include an assessment list panel 921 which is configured to present a list of assessments 5 with summarized information for each assessment 5.

Accordingly, the assessment list panel 921 may be in the form of a table which presents one or more of: an identifier for the assessment (which may be a name or title for the assessment, which may be a name of the deployment for example), the total number of candidates to whom the assessment 5 was made available, the ratio of passes to fails, the average score, the average time taken to complete the assessment, the date on which the assessment occurred (which may also include the time), and the identity of the assessment template 52 (such as the template ID or descriptor for the assessment template 52).

In some embodiments, each assessment 5 presented in the assessment list panel 921 is provided on the row of a table and, in some embodiments, each assessment 5 may be associated with a user selectable option 921a to navigate to the results analysis interface 9 to view representations of the results for that assessment 5.

In some embodiments, the results overview interface 92 includes a filter panel 922 with one or more fields 922a configured to receive from the assessor, via the administrator device 13, one or more filter criteria which may be used to filter the assessments shown in the assessment list panel 921. This filtering may be performed locally or in the assessment server 11. The one or more fields 922a may include options to filter by date, by information associated with the assessments 5 (such as one or more of the deployment tags), and/or a pass to fail ratio.

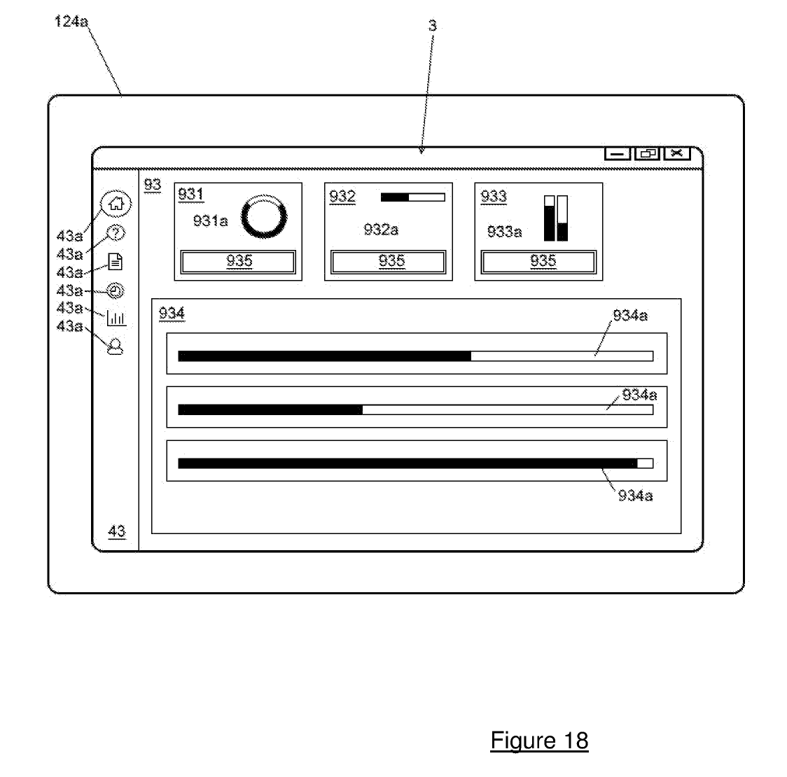

The one or more other user interfaces may include, for example, an assessor dashboard interface 93—see FIG. 18.

The assessor dashboard interface 93 may be configured to present to the assessor, via the administrator device 13, overview information about the operation of one or more aspects of the assessment system 1. In some embodiments, that information is limited to information associated with the accounts 113a or groups of accounts 113c which the assessor has privileges to access or view information about.

The assessor dashboard interface 93 may, for example, include a question summary panel 931, a template summary panel 932, a deployment summary panel 933 and an assessment summary panel 934.

The question summary panel 931 may include an overview of the body of questions 51. For example, the question summary panel 931 may present one or more of: the total number of questions in the body of question 51, the total number of questions added in a predetermined period or since the assessor last accessed the assessor dashboard interface 93 (i.e. the number of new questions), the number of questions which have been altered or for which new versions have been created in the predetermined period or since the assessor last accessed the assessor dashboard interface 93, the number of approved questions (which may include the number of approved versions of questions or this may be presented separately), the number of unapproved questions (which may include the number of unapproved versions of questions or this may be presented separately), and the like.

The question summary panel 931 may include a graphical representation 931a of one or more aspects of the aforementioned information.

The template summary panel 932 may include an overview of the assessment templates 52. For example, the template summary panel 932 may present one or more of: the total number of templates 52, the total number of templates 52 added in a predetermined period or since the assessor last accessed the assessor dashboard interface 93 (i.e. the number of new templates), the number of templates which have been altered or for which new versions have been created in the predetermined period or since the assessor last accessed the assessor dashboard interface 93, the number of approved templates (which may include the number of approved versions of templates or this may be presented separately), the number of unapproved templates (which may include the number of unapproved versions of templates or this may be presented separately), and the like.

The template summary panel 932 may include a graphical representation 932a of one or more aspects of the aforementioned information.

The deployment summary panel 933 may include an overview of the current deployments of assessments 5. Again, this may include information such as the total number of deployments, the total number of deployments which are awaiting the availability of the assessment 5 to occur, the total number of deployments for which the assessments 5 are currently available (i.e. currently available to be sat by the candidate(s)), the total number of deployments for which the assessments 5 were available but that availability has now ended.

The deployment summary panel 933 may include a graphical representation 933a of one or more aspects of the aforementioned information.

One or more of these summary panels 931,932,933, may include an assessor selectable option 935 to cause the presentation of one or more of the question management interface 45, the new question interface 46, the template management interface 47, the new template interface 48, the deployment management interface 49, and the new deployment interface 50.

The assessor dashboard interface 93 may include a summary of one or more assessments 5 in the assessment summary panel 934. This summary may include at least one bar 934a representing one or more of: the average score of the candidates who have completed the assessment 5, the proportion of candidates for an assessment 5 which have completed the assessment, the number of passes and fails of the assessment 5. One or more aspects of this information may be presented in other manners (in addition or instead of the at least one bar), such as in the form of text.

In accordance with some embodiments, when a candidate commences an assessment via the assessment device 12, an assessment instance 53 is sent to the assessment device 12. In some embodiments, the assessment instance 53 is sent as a data package with all of the questions for the assessment instance included in the data package. Thus, after the assessment instance 53 has been received from the assessment server 11, the assessment instance 53 can be accessed by the candidate irrespective of whether they subsequently lose access to the assessment server 11 over the network 2—e.g. due to a fault in the network 2.

The data package may be encrypted during transmission to the assessment device 12 and may be stored on the assessment device 12 (in the storage medium 123 associated therewith) in an encrypted form.

The browser application 3 (or other application) which may be used to present the assessment instance 53 to the candidate may decrypt the assessment instance 53 for presentation to the candidate via the assessment device 12.

The answers to the questions of the assessment instance 53 as entered into the assessment device 12 by the candidate may be recorded and stored by the assessment device 12 (e.g. in the associated storage medium 123). These answers may also be encrypted. In some embodiments, the key candidate response information 8 is also recorded and stored by the assessment device 12 and may be encrypted. The answers and/or key candidate response information 8 may be stored in a packet of data on the assessment device 12 and that packet of data may be in the form of a cookie which may be generated by the browser application 3 (or other application).

The storage of the answers and/or key candidate response information 8 ensures that a loss of the connection to the assessment server 11 will not prevent the candidate's answers from being recorded and the encryption, if used, may help to reduce the risk of subsequent manipulation of the answers via the stored data. In addition, a failure of the assessment device 12—such as a software crash—may mean that the stored information is retrievable.

The stored answer and/or key candidate response information 8 may be sent to the assessment server 11 (as sent data) at the completion of each question, at the completion of the assessment 5, or when the connection to the assessment server 11 (e.g. over the network 2) is available.

In some embodiments, the assessment server 11 may provide each of a plurality of assessment devices 12 with a predetermined time or predetermined delay after the completion of the assessment 5, for the answer and/or key candidate response information 8 to be sent to the assessment server 11. This may help to reduce the risk of high network traffic at the time of completion of an assessment 5 by a large number of candidates, for example.

In some embodiments, each time a candidate answers a question this is sent to the assessment server 11 and the recorded on the assessment device 12 may be updated. The same may be true each time the candidate causes new key candidate response information 8 to be generated.

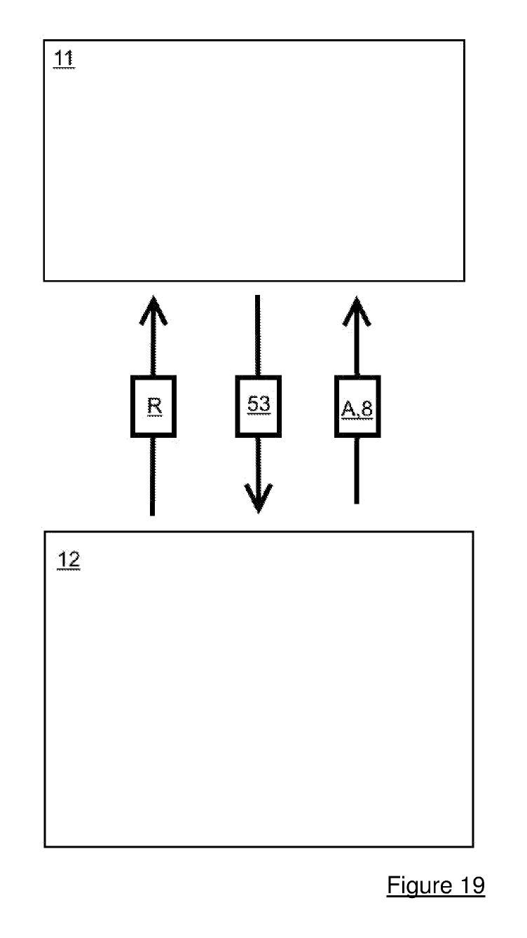

This process is generally depicted in FIG. 19. This figures shows an initial request, R, for an assessment instance 53 to be sent to the assessment device 12. In response an assessment instance is sent to the assessment device 12 from the assessment server 11. The assessment device 12 then, at a later time, sends back answer information, A, and key candidate response information 8.

In some embodiments, answer information, A, and key candidate response information 8 may be sent back more than once. For example, such information A,8 may be sent back each time a question is answered or an answer is changed, or may be sent back at predetermined (e.g. regular) times, or may be sent back when particular part of the assessment are completed (each part comprising a sub-set of the questions in that assessment instance 53).

As will be appreciated, in some embodiments, the key candidate response information 8 is dependent on accurate recordal of the time at which various different events may occur during a candidate's completion of an assessment 5.

Accordingly, there is a need to reduce the risk of a candidate attempting to tamper with the accurate recordal of time on their assessment device 12.

In some embodiments, when a request is sent from an assessment device 12 to the assessment server 11 for the delivery of an assessment instance 53 to the assessment device 12, that request may include an indication of the current time (i.e. the absolute time indicator) at which the assessment device 12 made the request. The assessment server 11 may be configured to receive this indication, as part of the sent data. This may, therefore, be a first time indicator.

In response to receipt of this indication with the request for an assessment instance 53 to be sent, the assessment server 11 may compare the received time indication with its own current time (i.e. its own absolute time indicator). The assessment server 11 may record the difference between the two times as a time difference for that assessment device 12. Accordingly the time difference may be stored (e.g. on the storage medium) in association with the account 113b which the candidate used to access the assessment system 1 or otherwise in association with the assessment device 12. This time difference may be a first time difference.

At the conclusion of the assessment 5, the answers and/or key candidate response information 8 may be sent to the assessment server 11 for marking by the assessment server 11. The sending of this information may include, for example, another indication of the current time (i.e. the absolute time indicator) at which the assessment device 12 sent the information. The assessment server 11 may be configured to receive this indication, as part of the sent data. This is an example of a second time indicator.

In response to receipt of this indication, the assessment server 11 may compare the received time indication with its own current time (i.e. its own absolute time indicator). The assessment server 11 may record the difference between the two times as a time difference for that assessment device 12 (e.g. a second time difference). Accordingly the time difference may be stored (e.g. on the storage medium) in association with the account 113b which the candidate used to access the assessment system 1 or otherwise in association with the assessment device 12. The time difference at the end of the assessment may be compared with the time difference when the assessment instance 53 was requested. A discrepancy or a significant discrepancy (i.e. more than a predetermined period) may indicate that cheating has occurred and the candidate's answers may be marked as void. In some embodiments, a notification or alert is sent to the candidate and/or the assessor.

In some embodiments, the assessment device 12 will send such a current time indication to the assessment server 11 periodically and the comparison may be performed during the assessment at one or more intervals. This may occur at substantially or pseudorandom intervals during the assessment 5, at regular intervals, or based on an event (e.g. the completion of a question). Again, a discrepancy or a significant discrepancy may indicate cheating and a notification or alert may be issued accordingly.

In some embodiments, this indication of the current time at the assessment device 12 will also be recorded and stored by the assessment device 12 (e.g. in the associated storage medium 123) and may be encrypted. This stored information may be sent to the assessment server 11 with the answers, for example.

As such the time information obtained during an assessment 5 may be compared, in the assessment server 11, with other time information—such as the time at the start and end of the assessment 5 as determined by either the assessment device 12 or server 11—to identify a discrepancy which may indicate that cheating has occurred. For example, if the time at which a particular question was answered is earlier than the time at which the assessment instance 53 was requested/sent, then there has likely been cheating.

In some embodiments, the assessment server 11 is configured to detect distinguish between requests for assessment instances 53 which are made legitimately via an assessment device 12 with an authenticated candidate from requests made without authentication. The assessment server 11 may be configured to ignore such requests. In some embodiments, after predetermined number of such attempts from an illegitimate device (i.e. without an authenticated user) then the assessment server 11 may be configured to block all requests (legitimate or not) originating from that network address (e.g. IP address).

In some embodiments, the or each assessment device 12 and/or the or each administrator device 13 may be configured to access the received served data and to send the sent data via a conventional Internet browser application 3. In some embodiments, however, a bespoke browser application 3 is provided. This bespoke browser application 3 may be available on the assessment server 11 for download to the or each assessment device 12 and/or the or each administrator device 13.

The bespoke browser application 3 may be, for example, a full screen application which cannot be minimised once open. The bespoke browser application 3 may be able to detect the opening of one or more predetermined applications (such as a calculator or other application or application which comes with the operating system) which may indicate that the candidate is cheating. The bespoke browser application may prevent the user from switching between applications. The bespoke browser application may detect the connection to the assessment device 12 and/or administrator device 13 of one or more other devices such as a storage medium. Again, these may indicate that the user is cheating.

The bespoke browser application 3 may be configured to prevent or substantially inhibit one or more of these activities which may indicate cheating. On detecting that a user is attempting such an activity, the bespoke browser application 3 may send an alert to the assessment server 11. In response to such an alert, the assessment server 11 may send the alert to one or more assessors, e.g. to one or more of the one or more administrator devices 13. In some embodiments, the bespoke browser application 3 will present a warning to the user of the detection of such an activity. In some embodiments, the bespoke browser application 3 may permit a predetermined number of such warnings to be issued before the alert is sent to the assessment server 11. In some embodiments, the sending of the alert may also cause the termination of the assessment 5.

In some embodiments, one or more aspects of the operation of the assessment server 11 may be performed by an invigilator device which acts as the assessment server 11 and which may act as a combination of the assessment server 11 and the administrator device 13. The invigilator device may be located in the same building or room as the one or more assessment devices 12 and may allow an invigilator to deploy an assessment and to monitor the answers being made by the candidates.

In some embodiments, one or more other inputs to the or each assessment device 12 may be monitored as part of the key candidate response information 8. This may include, for example, one or more images from the camera 124g and/or one or more sounds detect by the microphone 124d. This monitored information may be used in the further assessment of the candidate but may also be used to detect possible cheating. For example, one or more images from the camera 124g may be analysed to detect the presence of a book, another person, or an indication of there being another computing device present which the candidate may also be using (e.g. by analysing the image to look for the presence of a display screen, another keyboard, another mouse, or the like). Sounds may be analysed to detect the presence of another person providing answers to the candidate. This analysis may be performed locally or the data may be sent, as sent data, to the assessment server 11 for analysis. Again, similar action may be taken if potential cheating is detected—including one or more warnings and alerts. In some embodiments, the analysis is performed manually by an assessor accessing the one or more other inputs (e.g. on their administrator device 13) and, for example, listening to or viewing the one or more other inputs.

In some embodiments, the assessment server 11 is configured to compare a network address (e.g. an IP address) of an assessment device 12 (or administrator device 13) requesting information with a whitelist and/or a blacklist. If the network address is on the whitelist, then the assessment server 11 may process the request. Similarly, if the network address is not on the blacklist, then the assessment server 11 may process the request. Otherwise, the assessment server 11 may ignore the request.

In some embodiments, the assessment device 12 is further configured to collect information from which the identity of the candidate can be confirmed—in addition to the username and password discussed above. This may include, for example, the camera 124g capturing an image of the candidate's face and comparing this to an earlier image of the candidate. The earlier image of the candidate may have been taken at a juncture at which the candidate's identity was checked—e.g. during enrolment with an educational institute. In some embodiments, the candidate may provide a copy of an identity document (such as a passport) including a photograph or biometric data. The information obtained from the identity document may be compared with a captured image of the candidate to confirm the identity of the candidate. Other systems may be used to confirm the identity of the candidate including for example a smart card inserted into a reader connected to the assessment device 12. Similar mechanisms may be used, in some embodiments, to confirm the identity of the assessor.

In some embodiments, an assessment template 52 may include options to allow the assessor to cause the assessment instance 53 to be modified for particular candidates. For example, for candidates with particular markers in their account information 113a, the assessment template 52 may cause the generation of assessment instances 53 which allow more time for a question or for the assessment 5 as a whole, which ensure particular colours are used in one or more questions, which present text of a particular font size, and/or which present one or more of the aforementioned interfaces (including a question panel 72 and answer panel 73) through audio description in addition or instead of visually. Accordingly, assessment instances 53 may be generated taking into account candidate disabilities, for example, if those disabilities have been marked in the account information.

For the avoidance of doubt, the assessment system 1 may be configured to mark the answers provided by the candidates according to some embodiments. This marking may be performed by the assessment server 11 based on the information set out by the assessor in the new question interface 46. In some embodiments, marking of some questions may be performed manually and, therefore, an assessor must, using an administrator device 13, access the candidate's answer and enter a mark or other score for the answer into an appropriate field. A marking interface (not shown) may be provided for this purpose. The score will then be treated in the same manner as a score generated by the assessment server 11 performing the marking.

In some embodiments, candidates are informed of their mark and/or whether they passed or failed at the end of the assessment. A candidate that failed may be provided, via the assessment device 12, an option to resit the assessment and the assessment server 11 may generate a new assessment instance 53 for the candidate based on, for example, information entered by the assessor regarding the content of resit assessment instances 53.

In some embodiments, the assessment system 1 may provide a passing candidate with the option to download and/or print a certificate. This may be provided via the assessment device 12, for example.

In some embodiments, the certificate may include a picture of the candidate. This picture may be a picture which is taken as part of the operation of the assessment system 1 as described herein.

As will be appreciated, some embodiments seek to provide a robust and reliable assessment system 1 in which assessments can still, for example, be completed even if the connection between the assessment server 11 and assessment device 12 is poor. Embodiments also seek to provide additional information by which candidates can be assessed.

In accordance with some embodiments, the output from the operation of embodiments—such as the aforementioned representations—may be printed into a physical report for the candidate or assessment.

In some embodiments, the assessment server 11 is further configured to select the best candidate based on their combined score and confidence factor.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

### ADDITIONAL CONSIDERATIONS

When implemented in software, any of the sub-systems, modules, or units described herein may be stored in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

Thus, while the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

The particular features, structures, and/or characteristics of any specific embodiment may be combined in any suitable manner and/or in any suitable combination with one and/or more other embodiments, including the use of selected features with or without corresponding use of other features. In addition, many modifications may be made to adapt a particular application, situation and/or material to the essential scope or spirit of the present invention. It is to be understood that other variations and/or modifications of the embodiments of the present invention described and/or illustrated herein are possible in light of the teachings herein and should be considered part of the spirit or scope of the present invention. Certain aspects of the invention are described herein as exemplary aspects.

What is claimed is:

1. A tamper-resistant assessment system including:
an assessment server configured to generate an assessment instance including a question;
an assessment device including: an input sub-system, an output sub-system, and an input/output sub-system, the assessment device configured to:
send, using the input/output sub-system, a first current time indicator to the assessment server at a first time associated with requesting the assessment instance,
receive, using the input/output sub-system, the assessment instance from the assessment server,
present the question to a user using the output sub-system,
receive, via the input sub-system, an answer to the question,
send the answer to the assessment server, and
at a second time, subsequent to the first time and associated with conclusion of the assessment, send a second current time indicator to the assessment server,
wherein the assessment server is further configured to:
determine a first time difference between the first current time indicator and the current time when the first current time indicator is received by the assessment server,
determine a second time difference between the second current time indicator and the current time when the second current time indicator is received by the assessment server,
compare the first and second time differences, and
generate an alert when the first and second current time differences are different from each other by more than a predetermined period.

2. The assessment system according to claim 1, wherein the assessment device is further configured to monitor the time taken between the presentation of the question to the user and receipt of the answer, generate a time taken indicator representative of the time taken, and send the time taken indicator to the assessment server.

3. The assessment system according to claim 2, wherein the assessment server is further configured to determine a confidence factor based at least in part on the time taken indicator.

4. The assessment system according to claim 3, wherein the assessment device is further configured to monitor one or more changes of the answer received by the assessment device, generate an change indicator representing the number of changes of the answer, send the change indicator to the assessment server, and wherein the assessment server is further configured to determine the confidence factor based at least in part on the change indicator.

5. The assessment system according to claim 1, further including one or more administrator devices, wherein the alert is sent to at least one of the one or more administrator devices.

6. The assessment system according to claim 1, wherein the answer is stored on a storage medium of the assessment device.

7. The assessment system according to claim 6, wherein the answer is stored as a cookie.

8. The assessment system according to claim 6, wherein the assessment device is further configured to monitor the time taken between the presentation of the question to the user and receipt of the answer, generate a time taken indicator representative of the time taken, and to store the time taken indicator on the storage medium of the assessment device.

9. The assessment system according to claim 8, wherein the answer and time taken indicator are encrypted and stored as a cookie.

10. The assessment system according to claim 1, further including an administrator device,
wherein the assessment device is further configured to monitor the time taken between the presentation of the question to the user and receipt of the answer, generate a time taken indicator representative of the time taken, and send the time taken indicator to the assessment server,
wherein the assessment server is further configured to determine a confidence factor based at least in part on the time taken indicator and to determine a score based on the answer, and
wherein the administrator device is further configured to receive at least one representation of the confidence factor and score.

11. The assessment system according to claim 1, wherein the assessment server includes a storage medium on which is stored a body of questions, and at least one assessment template which defines one or more characteristics of an assessment, wherein the assessment server is further configured to generate the assessment instance such that the question included in the assessment instance is selected from the body of questions based at least in part on the assessment template.

12. The assessment system according to any preceding claim, further including one or more additional assessment devices, wherein the assessment server is further configured to generate one or more further assessment instances and to send each of the one or more additional assessment devices a respective one of the one or more further assessment instances.

13. A tamper-resistant assessment device including:
an input sub-system,
an output sub-system, and
an input/output sub-system, wherein the assessment device is configured to:
send, using the input/output sub-system, a first current time indicator to an assessment server at a first time,
receive, using the input/output sub-system, the assessment instance from the assessment server,
present the question to a user using the output sub-system,
receive, via the input sub-system, an answer to the question,
send the answer to the assessment server,
at a second time, subsequent to the first time, send a second current time indicator to the assessment server, and
receive an alert from the assessment server indicating cheating has occurred based at least in part on the first current time indicator and the second current time indicator.

14. The assessment device according to claim 13, wherein the assessment device is further configured to monitor the time taken between the presentation of the question to the user and receipt of the answer, generate a time taken indicator representative of the time taken, and send the time taken indicator to the assessment server.

15. The assessment device according to claim 14, wherein the assessment device is further configured to monitor one or more changes of the answer received by the assessment device, generate an change indicator representing the number of changes of the answer, send the change indicator to the assessment server.

16. A tamper-resistant assessment server configured to:
generate an assessment instance including a question;
receive a first current time indicator from an assessment device at a first time;
send the assessment instance to the assessment device;
receive an answer to the question from the assessment device;
at a second time, subsequent to the first time, receive a second current time indicator from the assessment device;
determine a first time difference between the first current time indicator and the current time when the first current time indicator is received;
determine a second time difference between the second current time indicator and the current time when the second current time indicator is received;
compare the first and second time differences; and
generate an alert when the first and second current time differences are different from each other by more than a predetermined period.

17. The assessment server according to claim 16, further configured to receive a time taken indicator from the assessment device.

18. The assessment server according to claim 17, further configured to determine a confidence factor based at least in part on the time taken indicator.

19. The assessment server according to claim 18, further configured to receive a change indicator from the assessment device, and determine the confidence factor based at least in part on the change indicator.

20. The assessment server according to claim 16, further configured to send the alert to an administrator device.
